(19) United States
(12) Patent Application Publication
(10) Pub. No.: US 2026/0336737 A1
(43) Pub. Date: Oct. 29, 2026

(54) HEIGHT ADJUSTABLE SEAT POSTS FOR BICYCLES

(71) Applicant: SRAM, LLC, CHICAGO, IL (US)

(72) Inventors: CHARLES DUNLAP, MANITOU SPRINGS, CO (US); TREVOR KRUGMAN, SPEARFISH, SD (US); ROBERT POWELL, COLORADO SPRINGS, CO (US); JOHN DEENY, SPEARFISH, SD (US)

(73) Assignee: SRAM, LLC, CHICAGO, IL (US)

(21) Appl. No.: 19/187,701

(22) Filed: Apr. 23, 2025

(51) Int. Cl. B62J 1/08

(52) U.S. Cl. CPC B62J 1/08; B62J 2001/085

(57) ABSTRACT

Height adjustable seat posts for bicycles are described herein. An example height adjustable seat post includes a first tube and a second tube configured in a telescopic arrangement. The seat post includes a valve disposed between the first and second chambers. The seat post includes an actuator to operate the valve between a closed state and an open state. The height adjustable seat post also includes a controller to operate the actuator with a power source to move the valve between the closed state and the open state. The controller is to control a current limit of effective current available to the actuator during operation of the valve.

### FIELD OF THE DISCLOSURE

This disclosure relates generally to bicycle components and, more specifically, to height adjustable seat posts for bicycles.

### BACKGROUND

Bicycles have a seat or saddle to support a rider in a seated position. The seat is typically connected to the bicycle frame by a seat post. On most bicycles, the seat post can be manually adjusted to raise or lower the height of the seat to accommodate riders of different heights. The height may also be adjusted to accommodate different riding conditions. Typically, the seat post is mechanically clamped to a tube of the bicycle frame. When the clamp is released, the seat post is slidable up and down relative to the tube of the bicycle frame to adjust the height of the seat. On some bicycles, the seat post is height adjustable during riding of the bicycle by employing a hydraulic assist mechanism. For example, manually actuated hydraulic height adjustable or “dropper” seat posts may use a hydraulic pressure differential within the post and require manual operation to adjust the seat post height. Some products may use ANT+ wireless communication technology allowing the rider to wirelessly adjust the seat post.

### SUMMARY

An example height adjustable seat posts includes a first tube and a second tube configured in a telescopic arrangement. One of the first tube or the second tube is to be coupled to a frame of the bicycle, and the other of the first tube or the second tube is to be coupled to a seat. The height adjustable seat post includes a first chamber, a second chamber, and a valve disposed between the first chamber and the second chamber. The valve is to control a fluid flow between the first and second chambers. The valve is operable between a closed state in which the fluid is blocked and an open state in which the fluid flow is enabled. The height adjustable seat post includes an actuator to operate the valve between the closed state and the open state. The height adjustable seat post includes a controller to operate the actuator with a power source to move the valve between the closed state and the open state. The controller is to control a current limit of effective current available to the actuator during operation of the valve. The controller is to set a first current limit and to change the current limit to a second current limit during operation of the valve.

An example bicycle component includes a first tube and a second tube configured in a telescopic arrangement, and a piston assembly in the first tube. The piston assembly divides the first tube into a first chamber and a second chamber. The first and second chambers are filled with a fluid. The piston assembly includes a valve to control flow of the fluid between the first and second chambers. The valve is operable between a closed state in which the fluid is blocked from flowing across the valve between the first and second chambers and an open state to enable the fluid to flow across the valve between the first and second chambers. The bicycle component includes an actuator to operate the valve between the closed state and the open state. The bicycle component includes circuitry to control a supply of electrical power to the actuator for a predetermined time period to enable the valve to change from the closed state to the open state or from the open state to the closed state, the circuitry to vary a current limit of available current to the actuator during the time period.

### BRIEF DESCRIPTION OF THE DRAWINGS

FIG. 1 is a side view of an example bicycle that may employ any of the example height adjustable seat posts disclosed herein.

FIG. 2 is a side view of an example height adjustable seat post in a fully extended position.

FIG. 3 is a side view of the example height adjustable seat post of FIG. 2 in a partially contracted position.

FIG. 4 is an enlarged view of an example control module that can be implemented on the example height adjustable seat post of FIG. 2.

FIG. 5 is a cross-sectional view of the example height adjustable seat post of FIG. 2 in the fully extended position.

FIG. 6 is a cross-sectional view of the example height adjustable seat post of FIG. 3 in the partially contracted position.

FIG. 7 is an enlarged view of the callout of FIG. 5 showing a cross-sectional view of an example piston assembly with an example valve implemented in the example height adjustable seat post.

FIG. 8 illustrates an embodiment of the example height adjustable seat post of FIG. 2 in which an example actuator is disposed in an alternative location.

FIG. 9 is a side view of another example piston assembly with an example valve that can be implemented in the example height adjustable seat post of FIG. 2. The example rotary valve is in a closed state.

FIG. 10 is a cross-sectional view of the example piston assembly taken along lines A-A of FIG. 9 showing the example valve in the closed state.

FIG. 11 is a cross-sectional view of the example piston assembly taken along lines B-B of FIG. 9 showing example openings in an example fixed disc.

FIG. 12 is a cross-sectional view of the example piston assembly taken along lines C-C of FIG. 9 showing an example rotatable disc in a closed position.

FIG. 13 is a side view of the example piston assembly of FIG. 9 in which the example valve is in an open state.

FIG. 14 is a cross-sectional view of the example piston assembly taken along lines D-D of FIG. 13 showing the example valve in the open state.

FIG. 15 is a cross-sectional view of the example piston assembly taken along lines E-E of FIG. 13 showing the example openings in the example fixed disc.

FIG. 16 is a cross-sectional view of the example piston assembly taken along lines F-F of FIG. 13 showing the example rotatable disc in an open position.

FIG. 17 is a cross-sectional view of another example piston assembly and example valve that can be implemented in the example height adjustable seat post of FIG. 2. FIG. 17 shows the valve in a closed state.

FIG. 18 shows the example valve of FIG. 17 in an open state.

FIG. 19 is a block diagram of the example controller and other components of the example height adjustable seat post of FIG. 2.

FIG. 20 is an example graph showing an example current limit profile with a fixed current limit.

FIG. 21 is an example graph showing an example current limit profile that decreases at a linear rate.

FIG. 22 is an example graph showing an example current limit profile similar to FIG. 21 for another type of valve.

FIG. 23 is an example graph showing an example current limit profile with a stepped-down current limit.

FIG. 24 is an example graph showing an example current limit profile that increases at a linear rate.

FIG. 25 is an example graph showing an example current limit profile with a stepped-up current limit.

FIG. 26 is an example graph showing an example current limit profile that decreases over a shorter time period.

FIG. 27 is an example graph showing an example current limit profile that is curvilinear.

FIG. 28 is an example graph showing an example current limit profile with motor braking.

FIG. 29 is an example graph showing an example current limit profile that has a low hold current at the end.

FIG. 30 is a flowchart representative of an example method that can be implemented by the example controller of FIG. 19.

FIG. 30 is a flowchart representative of example machine readable instructions and/or example operations that may be executed, instantiated, and/or performed by example programmable circuitry to implement the controller of FIG. 19.

FIG. 31 is a block diagram of an example processing platform including programmable circuitry structured to execute, instantiate, and/or perform the example machine readable instructions and/or perform the example operations of FIG. 30 to implement the controller of FIG. 19.

The figures are not to scale. Instead, the thickness of the layers or regions may be enlarged in the drawings. In general, the same reference numbers will be used throughout the drawing(s) and accompanying written description to refer to the same or like parts.

### DETAILED DESCRIPTION

Some modern bicycles include height adjustable seat posts, sometimes referred to as dropper seat posts. This type of seat post allows a rider to change the height of their seat while riding the bicycle. For example, the rider can actuate a seat post actuator (e.g., a button) on the handlebars and then push downward on the seat (e.g., with a sitting force/motion) to contract or compress the seat post, which thereby lowers the height of the seat. When the rider stops actuating the seat post actuator (e.g., releases the button), the seat post is maintained in the retracted position. Then, when the rider desires to raise the seat, the rider can actuate the seat post actuator again and the seat post extends or expands to move the seat back to the original height or to a desired height between the retracted position and the original height. This lowering ability can be advantageous when the rider is about to ride the bicycle down a steep decline. For instance, it is often desired to lower the seat when riding down a decline so that the rider can stand up and move their body freely without interference from the seat. This lowering ability can also be used to lower the seat before the rider encounters an incline, where the rider typically stands up and pedals. This adjustability can be used in many other scenarios as well.

Example height adjustable seat posts include an internal valve that controls the flow of fluid between a positive chamber and a negative chamber in the seat post. The valve is operable between a closed state to block the flow of fluid between the two chambers, which locks the seat post at a certain height, and an open state in which fluid is allowed to flow between the two chambers, which enables the seat post to expand or contract. The valve can be a linear valve or a rotary valve, for example.

Some known dropper seat posts rely on a mechanically or hydraulically actuated valve to change the height of the seat post. More recently, dropper seat posts have used battery powered electric actuators, such as an electric motor, controlled by an electrical signal to actuate the valve. The electric actuator changes the valve state upon receiving electrical power from a power source such as a battery. The height adjustable seat post includes a controller (e.g., a processor) to activate or deactivate the electric actuator to change the state of the valve. In particular, the controller controls and/or regulates the supply of electrical power from the power source to the electric actuator. The valve typically has linear or rotational movement limited range from open to closed and from closed to open. If the electrical current continues to be applied to the actuator for a time after the valve has moved to the end of its range to a valve stop position, the current for the time after increases (sometimes referred to as current stall) and generates heat and force. This increased current draw results in increased battery consumption, reduced component life, and potential motor heat damage.

Seat post controllers may use current sensing to detect current stall to determine when the valve has stopped and immediately shut off the actuator current. Other seat post controllers may use an actuator position encoder to determine when the valve is at its valve stop. When the valve reaches its stop as determined by its encoder position, the actuator current is immediately shut off to avoid excess current. In these approaches, the time to shut off the actuator current from user initiation is variable and is independent of the user input duration. Furthermore, delay may be introduced in detecting current stall and additional parts (e.g., current sensors, position encoders) that add weight and complexity to the seat post may be required.

Some seat post controllers may eliminate these current sensing/encoder control parts by allowing actuator current for a fixed or predetermined time greater than the time needed for the valve to move through its range. Current is applied, the actuator moves the valve through its range to its stop, then the current is shut off at a predetermined time relative to when the current was first applied. The predetermined time to supply current to the actuator is a fixed amount of time and is independent of the user input duration. The predetermined time is selected to prevent excess heat in the motor but still reduces battery life and increases valve stopping forces as some level of extra current beyond an expected current requirement is provided as a safety factor to ensure operation in various scenarios and environments. These known seat post controllers rely on a fixed magnitude current available to the actuator, referred to as the current limit. Typically, the valve requires a high starting current to overcome static friction (e.g., caused by seals and metal-on-metal contact) and mass inertia to start moving, requires lower current to keep moving throughout its range, and then requires higher current up to the current limit when the valve/actuator reaches the valve stop position. In known controllers, the current limit is set and held at a fixed current limit throughout the entire activation time. However, having a high current limit after the valve stop requires unnecessarily high actuator current that not only wastes energy but also generates high forces on the actuator and valve components. These high forces result in higher wear and tear on the parts, and therefore require the use of stronger, more expensive actuator and valve materials.

Disclosed herein are example height adjustable seat posts with controllers that implement a current limit that changes throughout the operation of the valve. In some examples, the current limit may be controlled across a fixed time period during which the valve is moved between a closed state and an open state. For example, the current limit may be decreased from the start time of the activation time period to the end time of the activation time period. This reduction in the current limit lowers the amount of current draw at the valve stop stage. This leads to a reduction in energy consumption by the actuator. Further, reducing the current limit can reduce the hard stop forces that occur at the valve end position, which reduces wear and tear on the actuator and valve components. As such, lighter, softer, and less expensive materials (e.g., plastic) can be used.

Disclosed herein are various example current limit profiles where the current limit is changed during the fixed activation time period. In some examples, the current limit is increased during the activation time period. In other examples the current limit is decreased during the activation time period. In some examples the current limit increases or decreases at a linear rate, while in other examples the current limit can increase or decrease at a curvilinear rate or in a stepped sequence.

In some examples disclosed herein, the current limit is controlled using variable width voltage pulses, also referred to as pulse width modulation (PWM) or voltage duty cycling. In this technique, the controller controls the current limit by rapidly switching the power source on and off at a fixed frequency. The controller can adjust the “on” time (duty cycle) of the pulses, which effectively regulates the average voltage delivered to the actuator and thereby controls the average current limit to the actuator. The longer the "on" time, the higher the average current limit available to the actuator, whereas the shorter the “on” time, the lower the average current limit available to the actuator. Therefore, the controller can change the current limit by changing (e.g., increasing or decreasing) the duty cycle. Additionally or alternatively, the controller can control the current limit using current limit hardware and/or measurements.

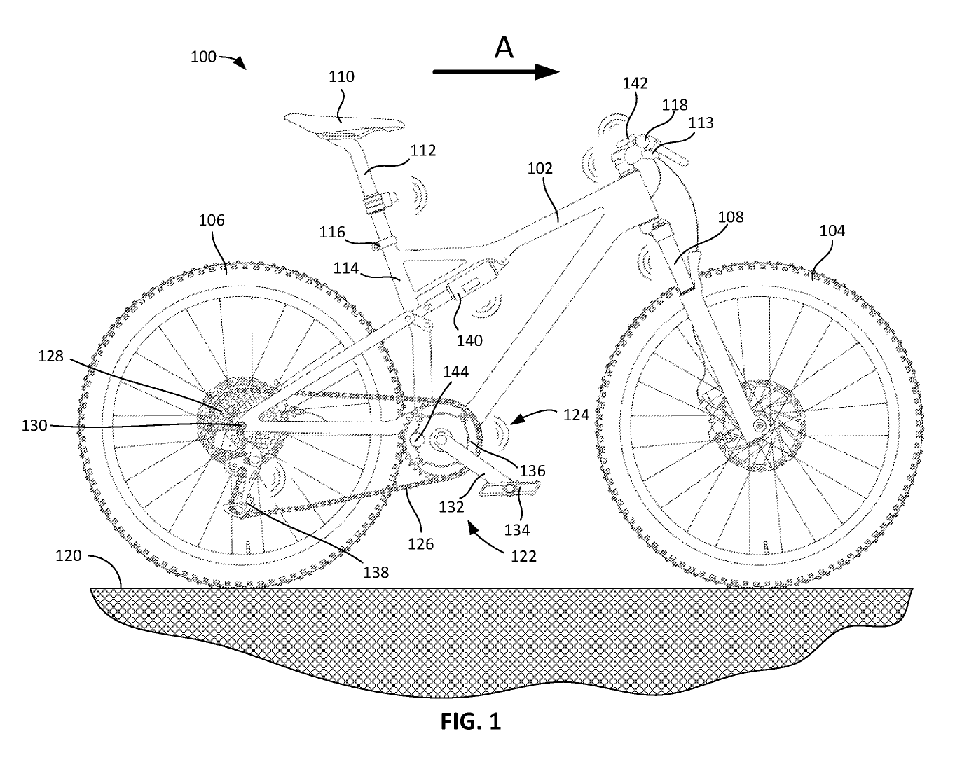

Turning now to the figures, FIG. 1 illustrates one example of a human powered vehicle on which the example seat posts disclosed herein can be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 (sometimes referred to as a saddle). The seat 110 is coupled to the frame 102 (e.g., near the rear end of the frame 102 relative to the forward direction A) via a seat post 112, examples of which are disclosed in further detail herein. In the illustrated example, the seat post 112 is coupled to a seat tube 114 of the frame 102. In some examples, the seat post 112 is coupled to the seat tube 114 by a clamp 116. The seat post 112 is height adjustable to raise or lower the seat 110. In some examples, the bicycle 100 includes a seat post actuator device, such as a seat post actuation button 113, to control the seat post 112. The bicycle 100 also includes handlebars 118 coupled to the frame 102 and the front fork 108 (e.g., near a forward end of the frame 102 relative to the forward direction A) for steering the bicycle 100. In some examples, the seat post actuation button 113 is mounted on the handlebars 118 to enable a rider to interact with the seat post actuation button 113 while riding the bicycle 100. The bicycle 100 is shown on a riding surface 120. The riding surface 120 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 122 that includes a crank assembly 124. The crank assembly 124 is operatively coupled via a chain 126 to a sprocket assembly 128 mounted to a hub 130 of the rear wheel 106. The crank assembly 124 includes at least one, and typically two, crank arms 132 and pedals 134, along with at least one front sprocket, or chainring 136. A rear gear change device 138, such as a derailleur, is disposed at the rear wheel 106 to move the chain 126 between different sprockets of the sprocket assembly 128. Additionally or alternatively, the bicycle 100 may include a plurality of front chainrings and a front gear change device to move the chain 126 between the plurality of chainrings.

The example bicycle 100 can include a suspension system having one or more suspension components. In the illustrated example, the bicycle 100 includes a rear suspension component 140. In this example, the rear suspension component 140 is implemented as or includes a shock absorber. In some examples, the front fork 108 is also implemented as a front suspension component. For example, a spring can be integrated into one of the legs and a damper can be integrated into the other leg. The front fork 108 and the rear suspension component 140 absorb shocks and vibrations while riding the bicycle 100 (e.g., when riding over rough terrain). In other examples, the front fork 108 and/or the rear suspension component 140 may be integrated into the bicycle 100 in other configurations or arrangements.

In some examples, one or more of the components of the bicycle 100 may include electronic components for controlling and/or monitoring various aspects of the bicycle 100. For example, the bicycle 100 of FIG. 1 includes a control device or bicycle computer 142 that is mounted on the handlebars 118. The bicycle computer 142 may wirelessly communicate with the seat post 112, the rear gear change device 138, the front fork 108, and/or the rear suspension component 140 to collect data and/or control operation of the respective components. The bicycle computer 142 may also wirelessly communicate with a power meter 144 of the crank assembly 124. The foregoing components may be paired to a wireless network.

While the example bicycle 100 depicted in FIG. 1 is a type of mountain bicycle, the example height adjustable seat posts disclosed herein can be implemented on other types of bicycles. For example, the example seat posts disclosed herein may be used on road bicycles, as well as bicycles with mechanical (e.g., cable, hydraulic, pneumatic, etc.) and non-mechanical (e.g., wired, wireless) drive systems. The example seat posts disclosed herein may also be implemented on other types of two-wheeled, three-wheeled, and four-wheeled human powered vehicles. Further, the example seat posts disclosed herein can be used on other types of vehicles, such as motorized vehicles (e.g., a motorcycle).

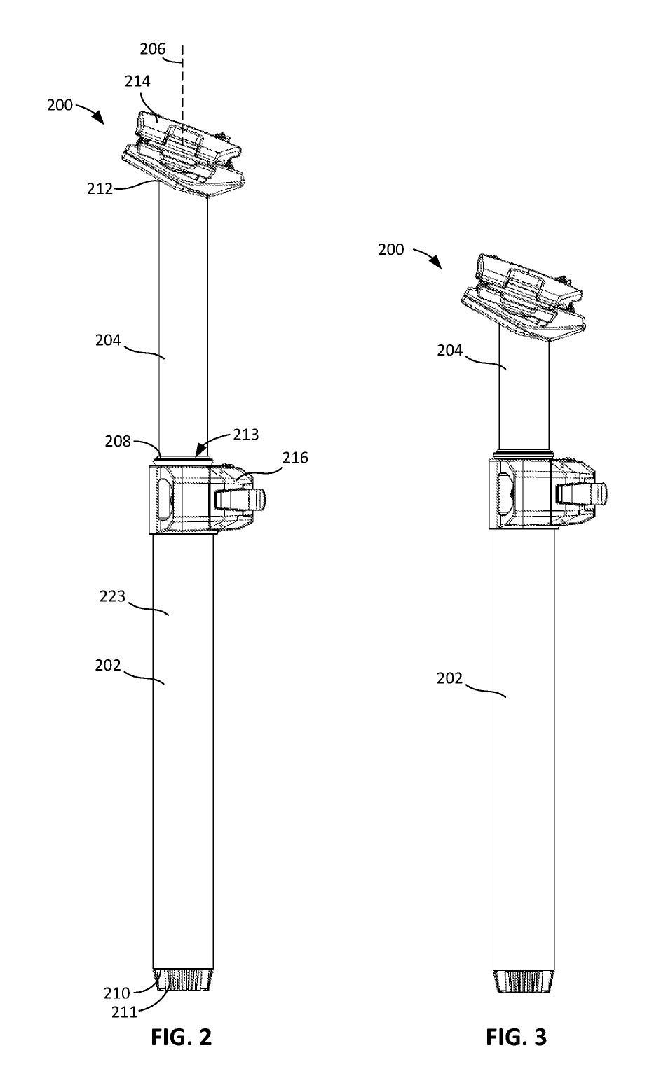

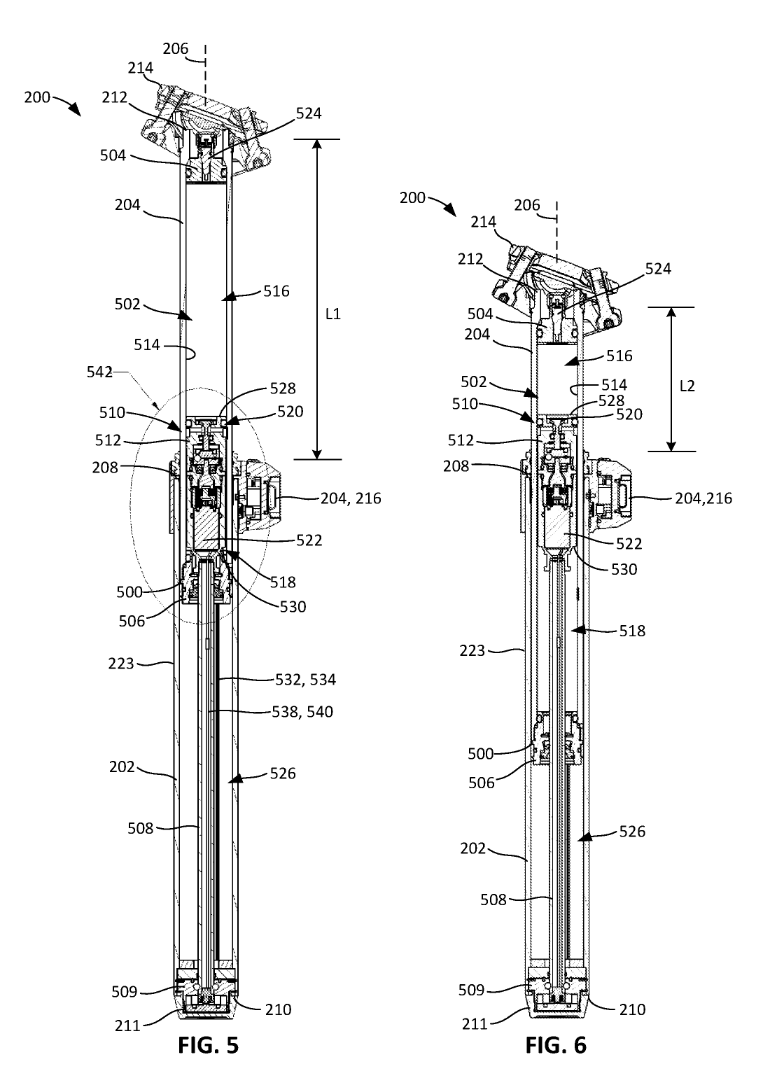

FIG. 2 is a side view of an example bicycle component in which the example valve actuation and current limit techniques disclosed herein can be implemented. In this example, the bicycle component is an example height adjustable seat post 200, which may also be referred to as a dropper seat post or seat post assembly. The example height adjustable seat post 200 that can be implemented as the seat post 112 on the bicycle 100 of FIG. 1. The length or height of the example seat post 200 is adjustable so that the height of the seat 110 (FIG. 1) can be raised or lowered. In the illustrated example, the seat post 112 includes a first tube 202, referred to herein as a lower tube 202, and a second tube 204, referred to herein as an upper tube 204. The lower and upper tubes 202, 204 may also be referred to as seat post portions or segments. As shown in FIG. 2, the lower and upper tubes 202, 204 are configured in a coaxial arrangement and aligned along an axis 206. The axis 206 corresponds to a central or longitudinal axis of the seat post 112. The lower tube 202 has a first end 208, referred to herein as an upper end 208, and a second end 210, referred to herein as a lower end 210, opposite the upper end 208. In this example, a lower cap assembly 211 is coupled to the lower end 210 of the lower tube 202. The upper tube 204 similarly has a first end 212, referred to herein as an upper end 212, and a second end 500 (shown in FIGS. 5 and 6), referred to herein as a lower end 500, opposite the upper end 212. The upper tube 204 and the lower tube 202 are configured in a telescopic arrangement. In particular, in this example, the upper tube 204 extends into an opening 213 in the upper end 208 of the lower tube 202. As such, the upper tube 204 is at least partially disposed in the lower tube 202. The upper tube 204 is slidable into and out of the opening 213 in the lower tube 202, which enables the overall height or length of the seat post 112 to change. In other examples, the lower and upper tubes 202, 204 can be configured such that the lower tube 202 extends into the lower end 500 of the upper tube 204.

In the illustrated example, the seat post 112 includes a seat clamp 214 that is coupled (e.g., welded, bolted, threaded, etc.) to the upper end 212 of the upper tube 204. The seat clamp 214 is used to couple the seat 110 (FIG. 1) to the seat post 112. In some examples, the seat clamp 214 includes two threaded fasteners that can be tightened to secure the seat 110 to the upper tube 204. In other examples, the seat post 112 can include other mechanisms for attaching to the seat 110.

When the seat post 112 is installed on the bicycle 100 (FIG. 1), the lower tube 202 is coupled to the frame 102 (FIG. 1). For example, the lower tube 202 can be inserted into the seat tube 114 (FIG. 1) and secured by the clamp 116 (FIG. 1). The upper tube 204 extends upward from the lower tube 202 and supports the seat 110 (FIG. 1). As disclosed in further detail herein, the seat post 112 has an internal valve that enables the upper tube 204 to move (e.g., slide) downward relative to the lower tube 202 and provides rebounding force to move the upper tube 204 upward relative to the lower tube 202. This enables a rider to easily lower the height of the seat 110 or raise the height of the seat 110. The seat post 112 is adjustable between a fully extended position (sometimes referred to as a top-out position), shown in FIG. 2, and a fully contracted position in which the upper tube 204 is moved into the lower tube 202 until a stop or limit is reached. The seat post 112 can also be expanded/contracted to any position between the fully extended position and the fully contracted position and maintained in place. For example, FIG. 3 shows an example in which the upper tube 204 has been partially moved into the lower tube 202. As such, the seat 110 (FIG. 1) would be lowered or closer to the ground compared to the position in FIG. 2. Therefore, the upper tube 204 and the lower tube 202 can be moved between at least a first position and a second position, where the first position may correspond to the fully extended position and the second position may correspond to the fully contracted position, or any position therebetween.

In the illustrated example of FIG. 2, the seat post 112 includes a control module 216. The control module 216 includes a power supply (e.g., a battery) and circuitry (e.g., a controller) to operate the internal valve. In this example, the control module 216 is coupled to an outer surface 223 of the lower tube 202 at or near the upper end 208 of the lower tube 202. However, in other examples, the control module 216 can be disposed in another location on the height adjustable seat post 200.

As an example operation, if a rider desires to lower the seat 110 (FIG. 1), the rider actuates a seat post actuator such as, in this example, the seat post actuation button 113 (FIG. 1). In FIG. 1 the seat post actuation button 113 is mounted on the handlebars 118 such that the rider can actuate the seat post actuation button 113 with one of his/her fingers (e.g., their thumb). Alternatively, the seat post actuation button 113 may be a lever or other type of user interface such a display device with a touch screen. When the seat post actuation button 113 is pressed, the seat post actuation button 113 transmits a signal (e.g., a wireless signal) to the control module 216. The control module 216 receives the signal from the seat post actuation button 113 and activates an electric actuator to open the internal valve, which is disposed in a pneumatic chamber in the upper tube 204, as disclosed in further detail herein. While the internal valve is open, the rider can push downward on the seat 110, which slides the upper tube 204 into the lower tube 202, as shown in the position of FIG. 3. In some examples, the rider can apply this force by sitting on the seat 110 and applying the downward force with their bottom. When the seat 110 reaches the desired height, the rider can release the seat post actuation button 113. In response to release of the seat post actuation button 113, the control module 216 closes the internal valve, which maintains the upper tube 204 in place relative to the lower tube 202. When the rider desires to raise the seat 110, the rider can press the seat post actuation button 113 again. The control module 216 receives the signal and opens the internal valve. When little or no downward force is acting on the seat 110, the internal pneumatic system pushes the upper tube 204 upward from the lower tube 202, thereby moving the seat 110 upward. When the desired position is reached, the rider can release the seat post actuation button 113, which causes the internal valve to close and holds the seat post 112 in the current position. Therefore, the seat post height can be easily adjusted by the rider.

In some examples, to activate the internal valve, the rider pushes and holds the seat post actuation button 113. As long as the seat post actuation button 113 is depressed, the valve is held in the open state, which enables the upper tube 204 to slide upward or downward relative to the lower tube 202. When the rider releases the seat post actuation button 113, the interval valve is closed, which maintains the upper tube 204 in place. However, in other examples, the system can be configured such that the rider may press and release the seat post actuation button 113 to cause the valve to open, and then the rider presses the seat post actuation button 113 a second time to close the valve.

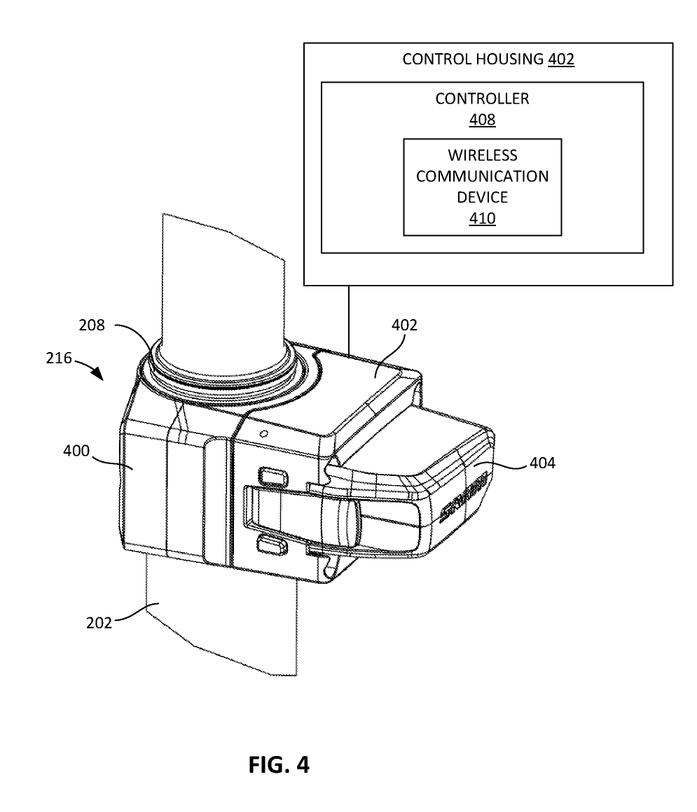

FIG. 4 is an enlarged view of the control module 216 on the lower tube 202. In the illustrated example, the control module 216 includes a collar 400, a control housing 402 coupled to the collar 400, and a power supply, in this example a battery 404, coupled to the control housing 402. The collar 400 is wrapped around the lower tube 202 and is used to couple the control module 216 to the lower tube 202. The control housing 402 contains electronic components for receiving control signals and operating the internal valve (e.g., opening the valve, closing the valve, etc.). For example, FIG. 4 shows a block diagram of the control housing 402. The control housing 402 includes a controller 408. The controller 408 may include a wireless communication device 410. The wireless communication device 410 can receive wireless control/command signals from the seat post actuation button 113 and/or another bicycle component such as the bicycle computer 142. Additionally, in some examples, the wireless communication device 410 can include a transmitter (e.g., a transceiver) and may send wireless control/command signals to the seat post actuation button 113 and/or other bicycle components such as the bicycle computer 142. In response to receiving a command, for example, the controller 408 activates an internal electric actuator that opens the interval valve in the upper tube 204 to enable the seat post 112 to expand or contract. When the seat post actuation button 113 is released, no control/command signals are received and the controller 408 activates the motor to close the valve, thereby maintaining the seat post 112 in position. In other examples, a second or separate control/command signal is received when the seat post actuation button 113 is released. The wireless communication device 410 is configured to communicate wirelessly, and as such includes one or more antennas. The wireless communication device 410 provides for wireless communication in any known or later developed format. Although the present specification describes components and functions that may be implemented in particular embodiments with reference to particular standards and protocols, the examples disclosed herein are not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Bluetooth®, ANT+^{TM}, ZigBee, WiFi and/or AIREA^{TM} standards may also, or alternatively, be used. Accordingly, replacement standards and protocols having the same or similar functions as those disclosed herein are considered equivalents thereof.

The battery 404 supplies electrical power to the controller 408, and the controller 408 regulates the supply of electrical power from the battery 404 to the internal electric actuator for operating the internal valve. The battery 404 may be rechargeable (e.g., via a physical cord or via wireless charging). In other examples, the battery 404 may be mounted remote from the seat post 200. For example, the battery 404 may be located on or internal to the frame 102 of the bicycle 100, for example in the case of a motorized bicycle or e-bike, and may be connected to the seat post 112 by electrical wires (e.g., one or more wires extending through or along the frame 102).

FIG. 5 is a cross-sectional view of the seat post 200 in the fully extended position corresponding to FIG. 2, and FIG. 6 is a cross-sectional view of the seat post 200 in a partially contracted position corresponding to FIG. 3. FIGS. 5 and 6 are described together. As shown in FIGS. 5 and 6, the upper tube 204 has a lower end 500. The lower end 500 is disposed in the lower tube 202. In FIG. 5, the amount of the upper tube 204 extending outward (e.g., upward) from the lower tube 202 is defined by a first length of L1, and in FIG. 6, the amount of the upper tube 204 extending outward from the lower tube 202 is defined by a second length L2, which is less than L1. As such, the overall height or length of the seat post 200 in FIG. 6 is less than the height or length of the seat post 200 in FIG. 5.

As shown in FIGS. 5 and 6, the upper tube 204 defines a sealed pressure chamber 502. The sealed pressure chamber 502 is filled with fluid (e.g., pneumatic gas), as discussed in further detail herein. The seat post 200 includes an upper sealhead 504 (e.g., a plug) coupled to the upper tube 204 at or near the upper end 212. The seat post 200 also includes a lower sealhead 506 coupled to the upper tube 204 at or near the lower end 500. The upper and lower sealheads 504, 506 seal the ends of the upper tube 204 to maintain the fluid in the sealed pressure chamber 502.

In the illustrated example of FIGS. 5 and 6, the seat post 200 includes a rod 508. The rod 508 is disposed in the lower tube 202 and coupled to the lower tube 202 (e.g., near the lower end 210), such that the rod 508 is fixed relative to the lower tube 202. For example, the lower cap assembly 211 includes a mount 509 disposed in and coupled to the lower tube 202 at the lower end 210. A bottom end of the rod 508 is coupled to the mount 509. The rod 508 extends upward through the lower tube 202 and through the lower sealhead 506 and into the upper tube 204. In particular, the rod 508 extends through the lower sealhead 506 and into the sealed pressure chamber 502 defined in the upper tube 204. The lower sealhead 506 is slidable up and down along the rod 508 as the seat post 200 expands or contracts.

In the illustrated example of FIGS. 5 and 6, the seat post 200 includes a piston assembly 510 disposed in the upper tube 204. The piston assembly 510 may also be referred to as a valve assembly or flow control assembly. The piston assembly 510 is disposed in the sealed pressure chamber 502 of the upper tube 204 and is coupled to the rod 508. As the seat post 200 expands or contracts, the piston assembly 510 moves closer to or further away from the upper and lower ends 212, 500 of the upper tube 204. The piston assembly 510 includes a piston 512 that is sealed against an inner surface 514 of the upper tube 204. The inner surface 514 of the upper tube 204 is slidable up and down along the piston 512 as the seat post 200 expands or contracts. The piston assembly 510 and, in particular, the piston 512, divides the sealed pressure chamber 502 of the upper tube 204 into a first chamber 516 (between the piston 512 and the upper sealhead 504) and a second chamber 518 (between the piston 512 and the lower sealhead 506). The first and second chambers 516, 518 may also be referred to as upper and lower chambers, respectively. The first chamber 516 is bound by the piston assembly 510, the upper sealhead 504, and the upper tube 204. The second chamber 518 is bound by the piston assembly 510, the lower sealhead 506, the upper tube 204, and the rod 508. The volumes of the first and second chambers 516, 518 change as the upper tube 204 moves up and down relative to the piston assembly 510. The first and second chambers 516, 518 are filled with a fluid. In this example, the seat post 200 is based on a pneumatic platform. Therefore, the first and second chambers 516, 518 can be filled with a pressurized gas, such as nitrogen or air. In other examples the first and second chambers 516, 518 can be filled with another type of compressible gas. The piston assembly 510 controls the flow of fluid (e.g., pressurized gas) across the piston 512 and between the first and second chambers 516, 518.

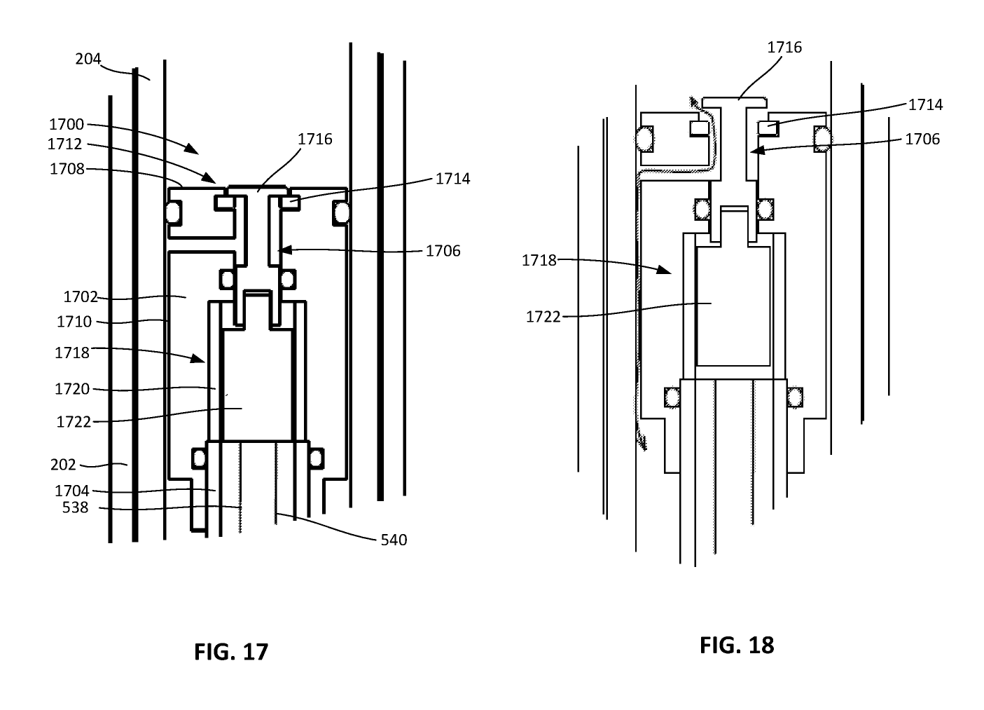

In the illustrated example of FIGS. 5 and 6, the seat post 200 includes a valve 520 and an actuator 522 (also referred to as an internal or electric actuator) to control the state of the valve 520. The actuator 522 can be activated or actuated to operate (e.g., switch) the valve 520 between the closed state and the and the open state. Although the present example describes the valve 520 as switchable between the closed state and the open state, it should be appreciated that various valves may be operated through and/or maintained at one or more intermediate states facilitating one or more intermediate levels of flow. In this example, the valve 520 and the actuator 522 are part of the piston assembly 510 and incorporated into and/or integrated with the piston 512. As such, the valve 520 is disposed between the first chamber 516 and the second chamber 518. In this example, the valve 520 is a poppet valve, which is a type of linear valve that includes a flow control member (e.g., a poppet) that is moveable in a linear direction to open or close the valve 520. However, in other examples, other types of valves can be used. The valve 520 can be operated (e.g., opened or closed) to control a fluid flow across the piston 512 between the first and second chambers 516, 518. In particular, the valve 520 is operable between a closed state and an open state. In the closed state, the valve 520 blocks the flow of fluid across the valve 520 (and the piston assembly 510) between the first and second chambers 516, 518, which maintains seat post 200 in its current position and, thus, maintains the lower and upper tubes 202, 204 in their current position. In the open state, the valve 520 enables the fluid to flow across the valve 520 (and the piston assembly 510) between the first and second chambers 516, 518, which enables the upper tube 204 to move relative to the lower tube 202 for adjusting the height of the seat 110 (FIG. 1). The actuator 522 can be activated to move the valve 520 between the open and closed states. In this example, the actuator 522 is an electric motor, such as a brushed, coreless direct-current (DC) motor. In other examples, other types of motors can be implemented. In other examples, the actuator 522 can be implemented by a solenoid, an example of which is shown in connection with FIGS. 17 and 18. Further, while in this example the actuator 522 is integrated into the piston assembly 510 in the upper tube 204, in other examples, the actuator 522 can be disposed in another location, such as attached to the lower end 210 of the lower tube 202.

In some examples, the seat post 200 includes a valve 524 (e.g., a Schrader valve, a Presta valve) to enable a user to add air (or another pneumatic fluid) to the sealed pressure chamber 502 or vent air from the sealed pressure chamber 502. In this example, the valve 524 is incorporated into the upper sealhead 504. A user can remove the seat clamp 214 and access the valve 524 to add or remove pneumatic fluid to/from the sealed pressure chamber 502.

In the illustrated example of FIGS. 5 and 6, the first chamber 516 is a positive pressure chamber and the second chamber 518 is a negative pressure chamber. The first chamber 516 and the second chamber 518 are pressure sealed chambers. The lower tube 202 defines a third chamber 526 between the lower sealhead 506 and the lower end 210 of the lower tube 202. The third chamber 526 is considered a pressure control chamber. The volume of the third chamber 526 changes based on the actuated position. In some examples, the third chamber 526 is vented to the atmosphere (e.g., via openings in the lower cap assembly 211) and therefore contains air at atmospheric pressure. However, in other examples, the third chamber 526 is also a pressure sealed chamber (e.g., containing pressurized air or nitrogen). In such an example, the air in the third chamber 526 may be compressed as the upper tube 204 is moved downward. This compressed air can provide a biasing force to return the seat post 112 to the fully extended position. In other examples, the third chamber 526 can have other mechanisms for compensating for the change in volume, such as a floating piston or a deformable bladder. The first chamber 516, the second chamber 518, and the third chamber 526 may be any number of shapes and/or sizes. For example, the first chamber 516, the second chamber 518, and the third chamber 526 may be cylindrically shaped (e.g., with outer diameters between 27 millimeters (mm) and 35 mm, respectively) and may be sized for a particular maximum post adjustment (e.g., 150 mm).

As shown in FIGS. 5 and 6, the piston 512 has a first side 528 facing the upper sealhead 504 and a second side 530 opposite the first side 528 and facing the lower sealhead 506. An axial surface area (as viewed along the axis 206) of the first side 528 of the piston 512 is greater than an axial surface area of the second side 530 of the piston 512. This is because a portion of the axial surface area of the second side 530 is reduced by the cross-sectional area of the rod 508. When the valve 520 is in the closed state and the seat post 200 is in the fully extended position (FIG. 5), the first chamber 516 acts as a spring and is configured to bias the upper tube 204 towards the fully extended position of the seat post 200. The first side 528 and the second side 530 of the piston 512 are sized and shaped, and the first chamber 516 and the second chamber 518 are respectively pressurized when the seat post 200 is in the fully extended position, such that the gas within the first chamber 516 supports the weight of the rider. In some examples, the seat 110 sags less than 10 mm as a result of the weight of the rider on the seat 110 when the seat post 200 is in the fully extended position. The seat post 112 operates because the axial surface area of the first side 528 of the piston 512 versus a pneumatic pressure ratio between the first chamber 516 and the second chamber 518 holds up the rider based on the force calculation. This is also dependent on the volume of the second chamber 518 at the fully extended position of the seat post 200. In the illustrated example of FIG. 5, the volume of the first chamber 516 is greater than the volume of the second chamber 518 when the seat post 112 is in the fully extended position. In some examples, the volume of the second chamber 518 may be no more than twenty percent of the volume of the first chamber 516 when the seat post 112 is in the fully extended position. In other examples, the first and second chambers 516, 518 may have a different volume ratio in the fully extended position. For example, the volume of the second chamber 518 may be no more than ten percent, five percent, or three percent of the volume of the first chamber 516 when the seat post 200 is in the fully extended position. This makes the seat post 200 act like a zero negative pressure preloaded pneumatic spring. This is the principal that holds up the rider with a feel the rider experiences as being rigid. At the fully extended position of the seat post 200, the seat 110 may move a small amount, but this movement is typically not perceivable to the rider.

As an example operation, assume the seat post 200 is in the fully extended position shown in FIG. 5 and the rider desires to lower the seat 110 (FIG. 1). The rider presses the seat post actuation button 113 (FIG. 1) on the handlebars 118 (FIG. 1). The controller 408 receives a signal from the seat post actuation button 113. In response to receipt of the signal, the controller 408 activates the actuator 522 to open the valve 520, i.e., move the valve 520 from the closed state to the open state. After a certain time period, the controller 408 deactivates the actuator 522, and the valve 520 remains in the open state. When the valve 520 is open, a force can be applied downward on the seat 110 to compress the seat post 200. For example, the rider can sit (or partially sit) on the seat 110 to apply downward pressure with his/her bottom. This downward pressure forces fluid (e.g., pressurized gas) from the first chamber 516 to flow through the valve 520 and across the piston 512 and into the second chamber 518. This enables the upper tube 204 to move downward relative to the upper tube 204, thereby lowering the seat 110. As the upper tube 204 is moved downward, the volume of the first chamber 516 is reduced and the volume of the second chamber 518 is increased. The rider can move (e.g., lower) the seat 110 to any position between the fully extended position and a fully contracted position. FIG. 6 shows the seat post 200 as in an intermediate position between the fully extended position and the fully contracted position.

When the seat 110 is at a desired position, such as the position in FIG. 6, the rider can release the seat post actuation button 113 (FIG. 1). The controller 408 activates the actuator 522 to close the valve 520, i.e., move the valve from the open state to the closed state. After a certain time period, the controller 408 deactivates the actuator 522, and the valve 520 remains in the closed state. When the valve 520 is closed, the fluid (e.g., pressurized gas) is prevented from flowing across the piston assembly 510 between the first chamber 516 and the second chamber 518. This limits or prevents further movement of the upper tube 204 relative to the lower tube 202. When the valve 520 is closed, the balance of forces in the system is such that the axial force acting on the first side 528 of the piston 512 is approximately equal to the axial force acting on the second side 530 of the piston 512. Using a compressible fluid such as air enables the pressure chamber to act as a compression spring when a downward force is applied on the upper tube 204. Therefore, when the rider sits on the seat 110, the seat post 200 can support the weight of the rider. In some examples, when the seat post 200 is in an intermediate position (between the fully extended position and the fully contracted position), the seat 110 may sag a small amount (e.g., 40 mm or less) as a result of the weight of the rider. The seat post 200 can be maintained at any position between the fully extended position and the fully contracted position. If the seat post 200 is moved to the fully contracted position, the seat clamp 214 contacts the upper end 208 of the lower tube 202 and/or the second sealhead 406 contacts the lower cap assembly 220. This provides a hard stop to prevent further movement. When the seat post 112 is in the fully contracted position, the seat 110 may not sag due to this hard stop.

When it is desired to raise the seat post 200 back to the fully extended position, the rider presses on the seat post actuation button 113 (FIG. 1), and the controller 408 (FIG. 4) activates the actuator 522 to open the valve 520. With no external downward force acting on the seat 110 (FIG. 1), the pressure in the first chamber 516 the upper tube 204 causes the upper tube 204 to move upward relative to the lower tube 202 back to the fully extended position. This is because the axial surface area of the first side 528 of the piston 512 is greater than the axial surface area on the second side 530 of the piston 512. As such, the force of the pressure in the first chamber 516 acting on the first side 528 of the piston 512 is larger than the force from the pressure in the second chamber 518 acting on the second side 530 of the piston 512. As a result, the upper tube 204 is forced upward to the fully extended position. As the upper tube 204 moves upward, fluid flows across the valve 520 from the second chamber 518 to the first chamber 516. Therefore, the axial force imbalance biases the seat post 200 towards the fully extended position. This enables the seat post 112 to automatically expand back to the fully extended position shown in FIG. 5. When the seat post 200 is fully extended, the rider can release the seat post actuation button 113, which activates the actuator 522 to close the valve and thereby maintain the seat post 112 in the fully extended position. Therefore, the pressurized gas in the first chamber 516 biases the upper and lower tubes 204, 202 away from each other, and the pressurized gas in the second chamber 518 biases the upper and lower tubes 204, 202 toward each other. While in the example of FIGS. 5 and 6 the seal pressure chamber 502 and the piston assembly 510 with the valve 520 are disposed in the upper tube 204, in other examples, the seat post 200 can be configured such that the seal pressure chamber 502 is formed in the lower tube 202 and the piston assembly 510 with the valve 520 are disposed in the sealed pressure chamber 502 in the lower tube 202.

As disclosed above, the control module 216 includes the controller (FIG. 4), which is configured to control and operate the actuator 522 to open and close the valve 520. In the illustrated example of FIGS. 5 and 6, the control module 216 is located on the outer surface 223 of the lower tube 202, at or near the upper end 208 of the lower tube 202, while the actuator 522 is coupled to the lower end 210 of the lower tube 202. The seat post 200 can include one or more wires and/or electrical connections to form an electrical path between the control module 216 and the actuator 522. This enables power and/or command signals to be transferred between the control module 216 and the actuator 522. For example, as shown in FIGS. 5 and 6, the seat post 200 includes first and second wires 532, 534 disposed in the lower tube 202. In some examples, the first and second wires 532, 534 are positive and negative wires. The first and second wires 532, 534 are electrically coupled to the controller 408. The first and second wires 532, 534 extend through the lower tube 202 to the actuator 522. In other words, in this example, the first and second wires 532, 534 extend between the upper end 208 and the lower end 210 of the lower tube 202. Further, the seat post 200 also includes first and second inner tube wires 538, 540. The first and second inner tube wires 538, 540 are disposed in the rod 508 and extend between the lower cap assembly 211 and the actuator 522. The lower cap assembly 220 includes one or more electrical connectors or wire bridging to electrically couple the outer tube wires 532, 534 and the respective inner tube wires 538, 540. The outer and inner tube wires 532, 534, 538, 540 can be soldered or crimped to the electrical connectors in the lower cap assembly 220. Therefore, the outer tube wires 532, 534, the inner tube wires 538, 540, and the electrical connectors form an electrical path between the control module 216 and the actuator 522. As such, positive and negative electrical connections are formed between the controller 408 and the actuator 522. The controller 408 can activate the actuator 522 by electrically coupling (e.g., via a switch) the wires 532, 534 to the battery 404.

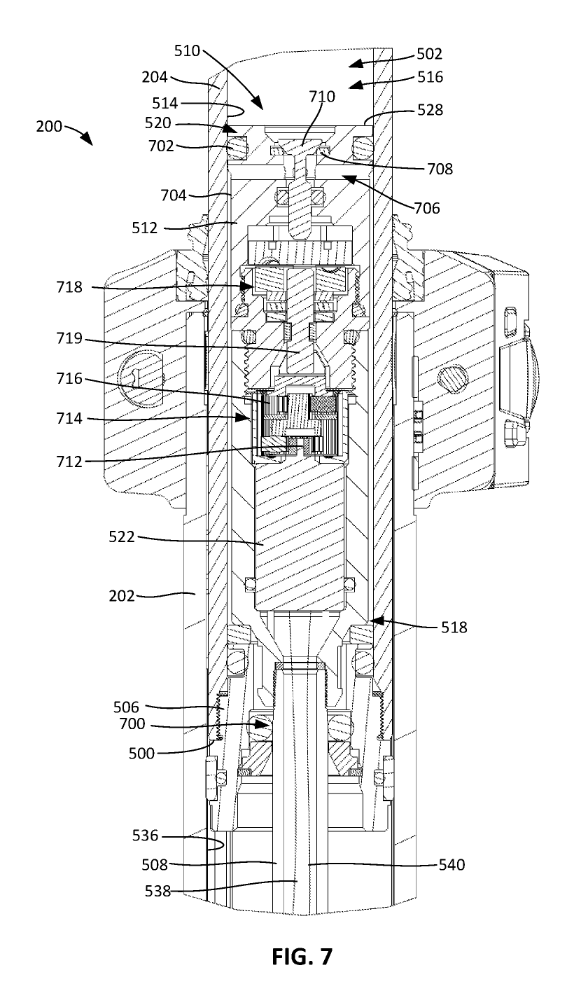

FIG. 7 is an enlarged view of the callout 542 of FIG. 5. As shown in FIG. 7, the lower sealhead 506 is threadably coupled to the lower end 500 of the upper tube 204 to seal the lower end of the sealed pressure chamber 502. The lower sealhead 506 is also sealed against and slidable along an inner surface 536 of the lower tube 202. The rod 508 extends through a channel 700 in the lower sealhead 506 and is coupled (e.g., threadably coupled) to the piston 512. The piston 512 can be constructed of one or multiple body portions that are coupled together.

In the illustrated example of FIG. 7, the piston assembly 510 includes a piston seal 702 (e.g., an o-ring) that is coupled to (e.g., disposed in a seal gland of) the piston 512 and in sealing contact with the inner surface 514 of the upper tube 204. The piston seal 702 is engaged with and seals against the inner surface 514 to prevent fluid leakage between the inner surface 514 of the upper tube 204 and an outer side surface 704 of the piston 512.

In the illustrated example of FIG. 7, the piston 512 defines a fluid passageway 706 extending between the first side 528 of the piston 512 and the outer side surface 704 of the piston 512. As such, the fluid passageway 706 fluidly connects the first chamber 516 and the second chamber 518. A seal ring 708 (also referred to as a seat) is disposed in the fluid passageway 706. In the illustrated example, the valve 520 includes a flow control member 710 (e.g., a poppet, a plug). The flow control member 710 is slidably disposed in the fluid passageway 706. In this example, the valve 520 is a linear valve. As such, the flow control member 710 is moveable in a linear direction between a closed position and an open position. In the closed position, which is shown in FIG. 7, the flow control member 710 is engaged with the seal ring 708 and blocks fluid flow through the fluid passageway 706. As such, fluid is prevented from flowing across the valve 520 (i.e., across the piston 512) between the first and second chambers 516, 518. In the open position, the flow control member 710 is moved upward such that the flow control member 710 is spaced from the seal ring 708 and therefore allows fluid flow through the fluid passageway 706 and across the valve 520 between the first and second chambers 516, 518. In this example, the valve 520 includes and/or is formed by the piston 512, the fluid passageway 706, the seal ring 708, and the flow control member 710. As such, the valve 420 is disposed in and/or formed at least partially by the piston 512. The valve 520 divides the upper tube 204 into the first chamber 516 and second chamber 518. In other examples, a seal ring may not be included. Instead, the flow control member 710 may directly engage and seal against a portion of the piston 512.

In the illustrated example, the actuator 522 is disposed in the piston 512. As shown in FIG. 7, the inner wires 538, 540 extend through the rod 508 and into the piston 512 and are electrically connected to the actuator 522. In this example, the actuator 522 is an electric motor having a rotatable output shaft 712. In the illustrated example, the piston assembly 510 includes a gear system 714 in the piston 512, operably coupled between the actuator 522 and the flow control member 710. The gear system 714 can include an arrangement of gears 716 to reduce a valve speed relative to a motor speed. In other words, the gear system 714 can provide a change a rotational speed (e.g., provide speed reduction) between the actuator 522 (electric motor) and the valve 520. In some examples, the gear system 714 is a planetary gear system, such as a two-stage planetary gear system, but in other examples can include one stage or more than two stages. In some examples, the gears 716 of the gear system 714 can be constructed of a softer material, such as plastic. Disclosed in further detail herein are example current limit profiles that reduce hard start and stop forces when opening and closing the valve 520, which reduces wear on the gear system 714, and therefore enables the use of softer material like plastic. Plastic gears may be less expensive and lighter than traditional metal gears. In other examples, the gears 716 can be constructed of hard materials such as metal or ceramic. In some examples, no gear system may be provided. Instead, a direct-drive configuration can be used.

In the illustrated example, the piston assembly 510 includes a cam assembly 718 that converts rotational motion to linear motion, such that rotation of the output shaft 712 of the actuator 522 (electric motor) causes linear movement of the flow control member 710 for opening or closing the valve 520. The piston assembly 510 includes a valve rod 719 coupled between the gear system 714 and the cam assembly 718. Rotation of the valve rod 719 in one direction causes the cam assembly 718 to move the flow control member 710 upward, and rotation of the valve rod 719 in the opposite direction causes the cam assembly 718 to move the flow control member 710 downward. Therefore, the actuator 522 (the motor) can be activated in one direction to move the flow control member 710 upward to the open position, and can be activated in the opposite direction to move the flow control member 710 (or enable the flow control member 710 to move via a spring) back to the closed position.

As discussed above, the valve 520 is operable between a closed state when the flow control member 710 is in the closed position and an open state when the flow control member 710 is moved to the open position. The open and closed states/positions may be defined by certain limits or stops. For example, the closed position occurs when the flow control member 710 engages the seal ring 708. In this position, the actuator 522 cannot further move the flow control member 710 down and, thus, forms a limit or stop. In some examples, the limit of the valve open position is defined by the cam assembly 718. For example, the cam assembly 718 may include two cams with balls between the cams. The balls may rest within certain grooves in the cams when the open position is reached, which prevents the cams from being further rotated.

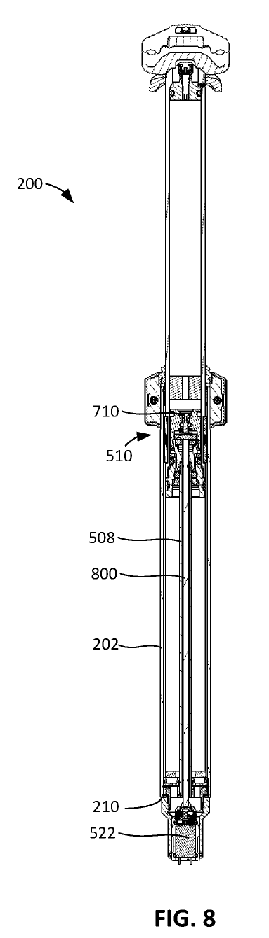

While in the example of FIG. 7 the actuator 522 is disposed in the piston assembly 510 in the upper tube 204, in other examples, the actuator 522 can be disposed in another location. For example, FIG. 8 is a cross-sectional view of the seat post 200 in which the actuator 522 is disposed at the lower end 210 of the lower tube 202. In this example, the seat post 200 includes a valve rod 800. The valve rod 800 is disposed in and extends through the rod 508. The valve rod 800 is coupled between the actuator 522 and the piston assembly 510. The actuator 522 can be activated to rotate the valve rod 800, which causes the flow control member 710 to move up or down between the open and closed positions. In the example of FIG. 8, the actuator 522 is coupled to but disposed outside of the lower tube 202. In other examples, the actuator 522 can be disposed in the lower tube 202 at or near the lower end 210.

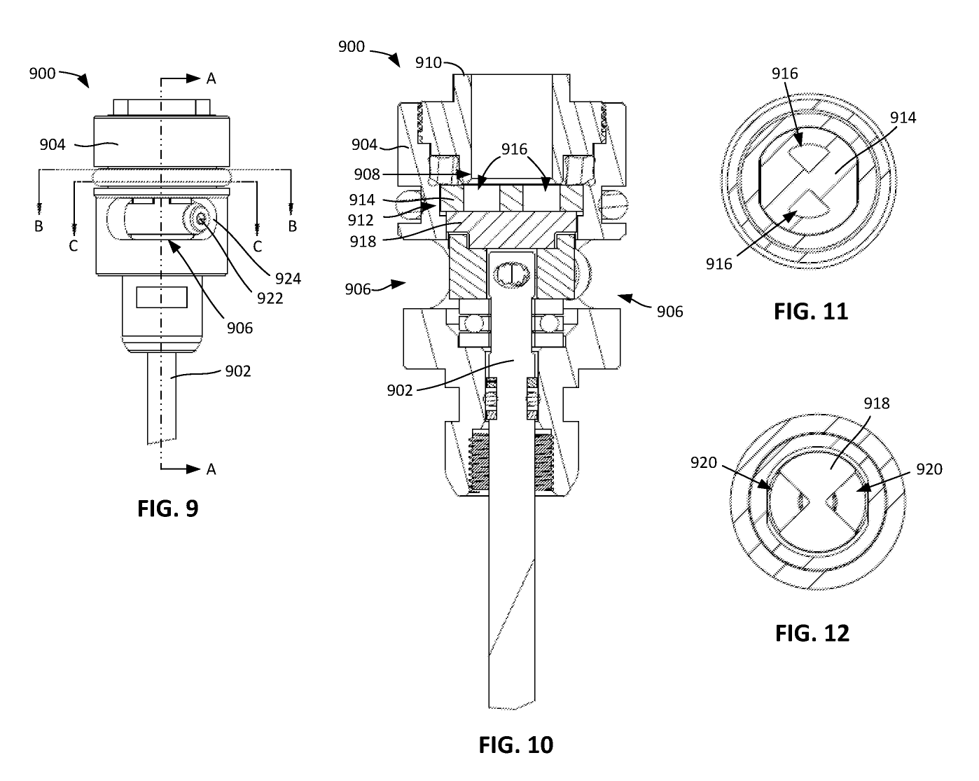

In some examples, instead of a linear valve, the seat post 200 can include another type of valve, such as a rotary valve. FIGS. 9-12 illustrate an example piston assembly 900 having a rotary valve. The piston assembly 900 can be implemented as the piston assembly 510 in the seat post 200. FIG. 9 is a side view of the piston assembly 900 and a valve rod 902 that can be used to operate the internal valve. FIG. 10 is a cross-sectional view of the piston assembly 900 and the valve rod 902 taken along line A-A of FIG. 9. FIG. 11 is a cross-sectional view taken along line B-B of FIG. 9 showing an axial view (e.g., a top view) of a fixed disc. FIG. 12 is a cross-sectional view taken along line C-C of FIG. 9 showing an axial view (e.g., a top view) of a rotatable disc in a closed position.

The piston assembly 900 includes a piston 904. The piston 904 includes radial openings 906 in an outer surface of the piston 904. The piston 904 defines a fluid passageway 908 between a top side 910 of the piston 904 and the radial openings 906. The piston assembly 900 includes a valve 912 formed by the fluid passageway 908. The valve 912 includes a fixed disc 914 disposed in the fluid passageway 908. The fixed disc 914 has openings 916 (e.g., channel, flow paths). The valve 912 also includes a flow control member, which, in this example, is a rotary disc 918. The rotary disc 918 is disposed in the fluid passageway 908 and engaged with the fixed disc 914. The rotatable disc 916 has notches 920 (FIG. 12). The valve rod 902 extends into the piston 904 and is coupled to the rotary disc 918. The valve rod 902 can be rotated by the actuator 522 to rotate the rotary disc 918 between a closed position and an open position. In FIGS. 9-12 the rotary disc 918 is in the closed position. When the rotary disc 918 is in the closed position, the notches 920 do not overlap with the openings 916 in the axial direction and, thus, the openings 916 are blocked by the rotatable disc 820. This prevents or blocks fluid flow across the fixed disc 914 and the rotary disc 918 and between the first and second chambers 516, 518 (FIG. 5).

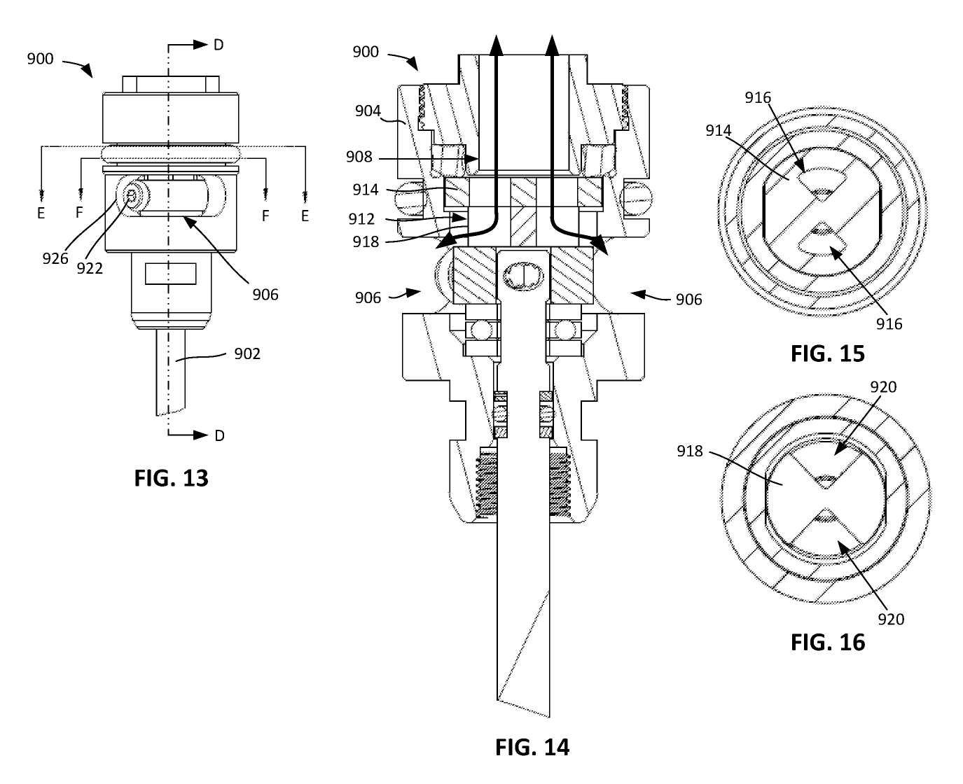

FIGS. 13-16 are similar views of the piston assembly 900 and the valve rod 902 as FIGS. 9-12, but showing the valve 912 in the open state. In particular, the valve rod 902 has been rotated about a quarter turn (e.g., 90°) by the actuator 522 (FIG. 5) and moved the rotary disc 918 to the open position. As shown in FIGS. 15 and 16, the notches 920 in the rotary disc 918 are at least partially overlapping with the openings 916 in the fixed disc 914 in the axial direction. As such, fluid can flow in the axal direction through the openings 916 in the fixed disc 914 and between the first and second chambers 516, 518 (FIG. 5).

As shown in FIGS. 9 and 13, the piston assembly 900 includes a stop bolt 922 that extends through one of the radial openings 906 and is coupled to the valve rod 902. As shown in FIG. 9, when the valve 912 is in the closed position, the stop bolt 922 engages a first end 924 (e.g., a stop surface) of the radial opening 906. This limits or prevents the valve rod 902 (and, thus, the rotary disc 918) from being rotated further in the counter-clockwise direction (when viewed from FIGS. 11 and 12). As such, this forms a stop when the valve 912 is in the closed state. Similarly, when the valve 912 is rotated a quarter turn to the open position shown in FIG. 13, the stop bolt 922 engages a second end 926 of the radial open 906. This limits or prevents the valve rod 902 (and, thus, the rotary disc 918) from being rotated further in the clockwise direction (when viewed from FIGS. 15 and 16). As such, this forms a stop when the valve 912 is in the open state.

As disclosed above, in some examples, the actuator 522 can be implemented by an electric motor. In other examples, the actuator 522 can be implemented by a solenoid. For example, FIG. 17 illustrates an example piston assembly 1700 with a linear valve and a solenoid. The piston assembly 1700 can be implemented as the piston assembly 510 in the seat post 200. The piston assembly 1700 includes a piston 1702 coupled (e.g., threadably coupled) to a rod 1704 (which may correspond to the rod 508). The piston 1702 defines a fluid passageway 1706 between a top side 1708 of the piston 1702 and an outer surface 1710 of the piston 1702. The piston assembly 1700 includes a valve 1712 to control the flow of fluid across the piston assembly 1700. The valve 1712 includes a seal ring 1714 (which may be referred to as a seat) in the fluid passageway 1706. The valve 1712 includes a flow control member 1716 slidably disposed in the fluid passageway 1706. The flow control member 1716 is moveable in a linear direction (up or down in FIG. 17) between a closed position and an open position. In the closed position, which is shown in FIG. 17, the flow control member 1716 is engaged with the seal ring 1714, which blocks fluid flow through the fluid passageway 1706 and therefore blocks fluid flow between the first and second chambers 516, 518. FIG. 18 shows the flow control member as moved to the open position. In FIG. 18, the flow control member 1716 has been moved upward and is now spaced from the seal ring 1714, which enables fluid flow through the fluid passageway 1706 between the first and second chambers 516, 518.

In this example, the piston assembly 1700 includes a solenoid 1718 disposed in the piston 1702. The inner wires 538, 540 are connected to the solenoid 1718, which enable the controller 408 (FIG. 4) to activate or deactivate the solenoid 1718. The solenoid 1718 includes a core with coil 1720 and an armature 1722 (which may also be referred to as a plunger). In this example, when the solenoid 1718 is activated, the armature 1722 is moved in the upward (first) direction to move the flow control member from the closed position to the open position. When the solenoid 1718 is deactivated, the armature 1722 and the flow control member 1716 move downward such that flow control member 1716 is returned to the closed position and engaged with the seal ring 1714. In some examples, the solenoid 1718 can include a return spring to bias the armature 1722 downward. However, in other examples, the solenoid 1718 does not include a return spring. Instead, when the solenoid 1718 is deactivated, the air pressure differential on the flow control member 1716 biases the flow control member 1716 and the armature 1722 in the downward (second) direction. As such, when the solenoid 1718 is deactivated, the flow control member 1716 is moved downward and the valve 1712 is closed. In some examples, the closed position is defined by a limit when the flow control member 1716 engages the seal ring 1714, and the open position is defined by a limit when the armature 1722 engages a shoulder or stop surface in the piston 1702.

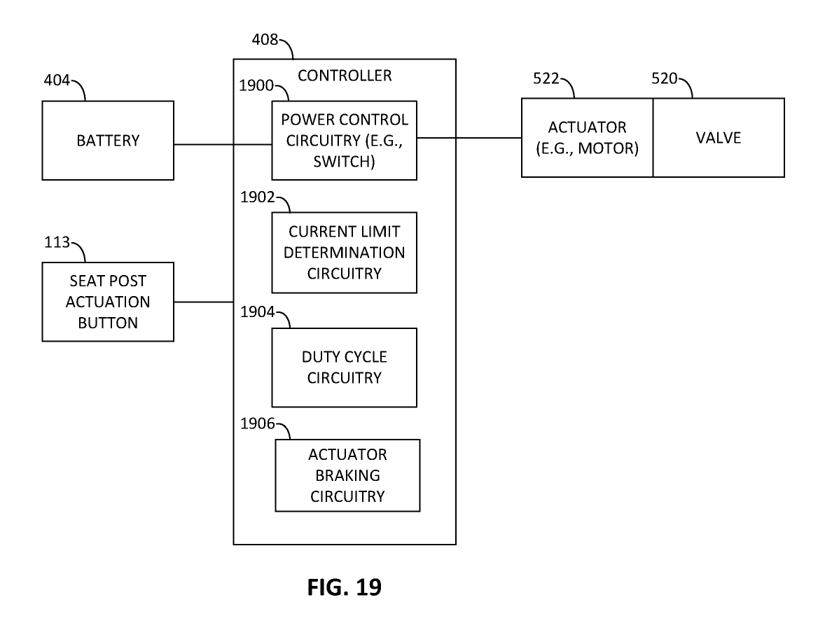

FIG. 19 is a block diagram of an example implementation of the controller 408 of FIG. 4. The controller 408 and, more specifically, circuitry blocks 1900-1906 of the controller may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the controller 408 and, more specifically, the circuitry blocks 1900-1906, may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 19 may, thus, be instantiated at the same or different times. Some or all of the circuitry of FIG. 19 may be instantiated, for example, in one or more threads executing concurrently on hardware and/or in series on hardware. Moreover, in some examples, some or all of the circuitry of FIG. 19 may be implemented by microprocessor circuitry executing instructions and/or FPGA circuitry performing operations to implement one or more virtual machines and/or containers.

Example operations are described in connection with the valve 520, but can similarly be implemented in connection with any of the other examples valves disclosed herein. The controller 408 is configured to activate the actuator 522 to control the state of the valve 520. For example, when the rider presses the seat post actuation button 113, the controller 408 receives a signal (e.g., a wireless signal) from the seat post actuation button 113 and activates the actuator 522 to move the valve 520 from the closed state to the open state. The controller 408 deactivates the actuator 522, and the valve 520 remains in the open state (e.g., due to latching). While the valve 520 is in the open state, the seat post 200 can be contracted or expanded to adjust the height of the seat 110. Once the seat 110 is at the desirable height, the rider releases the seat post actuation button 113. The controller 408 receives a signal or otherwise senses (from a lack of a signal) the release of the seat post actuation button 113. In response to release of the seat post actuation button 113, the controller 408 activates the actuator 522 to move the valve 520 from the open state to the closed state, and then deactivates the actuator 522. When the valve 520 reaches the closed state, the seat post 200 is locked in the current height. The valve 520 remains in the closed stated until the actuator 522 is again activated.

The controller 408 is electrically coupled (e.g., via one or more wires, traces, etc.) to a power source, such as the battery 404. The controller 408 is also electrically coupled to the actuator 522. For example, as disclosed above, the controller 408 is electrically coupled to the actuator 522 via the wires 532, 534, 538, 540 (FIG. 5). As shown in FIG. 19, the controller includes power control circuitry 1900. The power control circuitry 1900 can activate or deactivate the actuator 522 by controlling the supply of electrical power from the battery 404 to the actuator 522. In particular, the power control circuitry 1900 includes one or more switches (e.g., transistors). The switch(es) can be closed to electrically couple (e.g., form a closed circuit between) the battery 404 to the actuator 522 and thereby activate the actuator 522, or can be opened to disconnect the actuator 522 from the battery 404 to thereby deactivate the actuator 522. Therefore, the controller 408 is configured to operate the actuator 522 with the battery 404 (e.g., by electrically coupling the actuator 522 to the battery 404) to move the valve 520 between the closed state and the open state.

When it is desired to open or close the valve 520, the power control circuitry 1900 activates the actuator 522 for a fixed or predetermined time period, sometimes referred to herein as the activation time period, so that the valve 520 is switched from the open state to the closed state, or vice versa. The time period is long enough to ensure the flow control member 710 is fully moved from one of the open position or the closed position to the other one of the positions. The time period has a start time and an end time. At the start time, the power control circuity 1900 forms an electrical connection (e.g., a closed circuit) between the battery 404 and the actuator 522 such that electrical power is supplied to activate the actuator 522. At the end time, the power control circuitry 1900 ceases or cuts off the electrical connection (e.g., forms an open circuit) between the battery 404 and the actuator 522 to thereby deactivate the actuator 522.

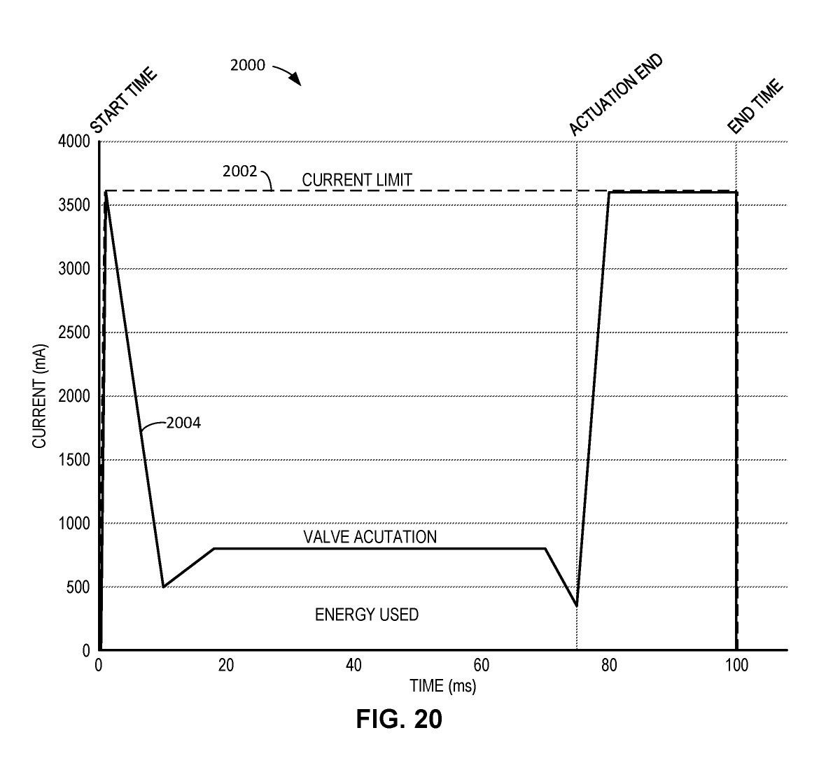

In some examples, as discussed in further detail herein, the controller 408 sets and/or otherwise controls a current limit during the activation of the actuator 522. The current limit is the effective available current that the actuator 522 can draw during operation of the valve 520. The effective current available may be the actual maximum current available or an average current limit, for example, controlled by pulse width modulation disclosed in further detail herein. The actuator 522 may draw less current, but cannot draw more than the current limit set by the controller 408. Further, the controller 408 is configured to change or vary the current limit during the activation time period. The controller 408 includes current limit determination circuitry 1902. The current limit determination circuitry 1902 determines the current limit(s) to be implemented during the time period. FIGS. 20-29 illustrate example current limit profiles that can be implemented by the controller 408 during the activation time period.

The power control circuity 1900 controls the current limit during the activation time period based on the current limit(s) or current limit profile determined by the current limit determination circuitry 1902. In some examples, the current limit can be controlled via voltage duty cycling using pulse width modulation. Pulse width modulation controls the current limit by rapidly switching the power source on and off at a fixed frequency. The controller 408 includes duty cycle circuitry 1904 that controls the pulse width of the voltage pulses. In particular, the duty cycle circuity 1904 controls the power control circuitry 1900 to cycle on and off at a certain frequency and controls the “on” time or voltage pulse width based on the desired current limit. A longer “on” time results in a higher current limit, whereas a shorter “on” time results in a lower current limit. The duty cycle circuit 1904 can adjust the duty cycle up or down depending on the current limit or current limit profile set by the current limit determination circuity 1902. Thus, the duty cycle circuit 1904 can change the current limit by changing (e.g., increasing or decreasing) the duty cycle of the supply of electrical power to the actuator 522.

In other examples, the controller 408 can include other hardware for controlling the current limit. For example, the controller 408 may include a linear regulator, such as a linear voltage regulator that uses analog voltage control to provide a stable voltage to control current. Another example linear regulator can utilize a current source with an operational amplifier (op-amp) with a sense resistor to create a constant current source. As another example, the controller 408 can utilize switched-mode current regulators (e.g., without PWM). For example, instead of using a PWM signal, the controller 408 can include a dedicated current-mode control buck or boost regulator. As another example, the controller 408 can implement hysteretic current control using a comparator to turn switching on and off at a controlled rate without fixed-frequency PWM. As another example, the controller 408 can implement linear transistor-based current control techniques. For example, the controller 408 can include a bipolar junction transistor (BJT) in active mode, such as in a current-mirror configuration or with a base drive circuit to control current linearly. As another example, the controller 408 can include a metal-oxide-semiconductor field-effect transistor (MOSFET) in linear mode, such as a MOSFET with a gate voltage set by a feedback loop that can act as a variable resistor to regulate current. As another example, the controller 408 can include a digital-to-analog converter (DAC) to generate a smooth analog control voltage that can be used to set the current limit in an analog current control circuit. As another example, the controller 408 can include magnetic or mechanical devices. For example, in some alternating current (AC) applications, the controller 408 can include a saturable reactor to control current via a magnet core saturation. As another example, the controller 408 can include one or more variable resistors (e.g., Rheostats) to control the current limit. In other examples, any other suitable method of regulating power may be provided. Various methods of power regulation to control an effective current include analog and digital methods such as dither, Shannon decoding, and/or maximum power point tracking may be implemented.

In some examples, the controller 408 includes actuator braking circuitry 1906. The actuator braking circuitry 1906 can be used to electrically couple the positive and negative terminals or wires of the actuator 522 to short the actuator 522 to apply actuator braking (e.g., motor braking). Examples of actuator braking are disclosed in further detail herein.

FIG. 20 is a graph 2000 showing a typical current profile implemented in known seat posts. The X-axis is time in milliseconds (ms), and the Y-axis is current in milliamps (mA). The controller 408 activates (i.e., supplies electrical power to) the actuator 522 over a fixed or predetermined time period, which, in this example, is 100 ms. In other examples the fixed time period can be longer or shorter. The time period has a start time (at 0 ms) and an end time (at 100 ms). At the start time, the controller 408 begins activation of the actuator 522, and at the end time, the controller 408 ceases activation of the actuator 522. The dashed line represents a current limit 2002, which is the maximum or highest amount of current made available by the controller 408. In other words, the current limit is the maximum current allowed to the actuator 522. The actuator 522 can draw less current, but cannot draw more current than the current limit. The solid line represents the current measurement or current draw 2004 (sometimes referred to as current trace), which is the actual amount of current that the actuator 522 draws from the power source during activation. The graph 2000 is representative of a valve opening operation (i.e., from the closed state to the open state), but can also represent a valve closing operation.

At the start time, the controller 408 connects the battery 404 to the actuator 522 to activate the actuator 522. The controller 408 controls the current limit 2002 at the start time. In this example, the current limit 2002 remains fixed or constant (e.g., at 3600 mA) throughout the duration of the time period. At the start time, the current draw 2004 rises immediately to the current limit 2002, then drops below the current limit for a period of time while the valve parts are moving, then spikes again to the current limit 2002, until the end time at which power is cut off and the current draw 2004 drops to zero. The initial spike at the beginning of activation (0 ms to about 2 ms) is due to relatively high forces needed to start the movement of the valve, such as overcoming any static friction from the stationary component and/or overcoming any pressure bias. As such, the actuator 522 draws the maximum current at the beginning of activation. Once the components of the valve start to move (e.g., slide, rotate, etc.), less force is needed to keep the components moving, so the current draw 2004 drops to a lower amount (e.g., 750 mA), which is shown in the middle section (about 2 ms to about 75 ms). When the valve 520 nears or reaches its end position, which is usually defined by a hard stop, the actuator 522 again draws the maximum current, which is shown by the high value from about 80 ms to 100 ms. Then, at the end time of 100ms, the actuator 522 is deactivated and the current drops to zero. Therefore, when high forces are exerted by the valve 520 on the actuator 522, such as a starting valve movement or a valve hitting its ending stop, the current draw 2004 to the actuator 522 is at the current limit 2002. At times when the valve 520 is moving more freely, indicated by the valve actuation period in the middle, the current draw 2004 is less than the current limit 2002.

As can be seen from FIG. 20, the current limit 2002 is a fixed value that the starting current reaches and the ending current reaches. The area under the current draw 2004 is the energy consumed (e.g., joules). This is the energy consumed from the power source, e.g., the battery 404, during the valve opening operation. The high value ending current from 80 ms to 100 ms results in a relatively large area under the curve and therefore relatively high energy usage. The high value ending current from 80 ms to 100 ms also results in a greater valve stop force and higher stress on the internal actuator parts and valve parts, such as the gears or gear box. The valve actuation middle portion of the current draw 2004 rises slightly at its beginning, flattens, then lowers slightly at its ending, which i typical of a linear style valve that may have a poppet pressure bias and latching bias characteristic.

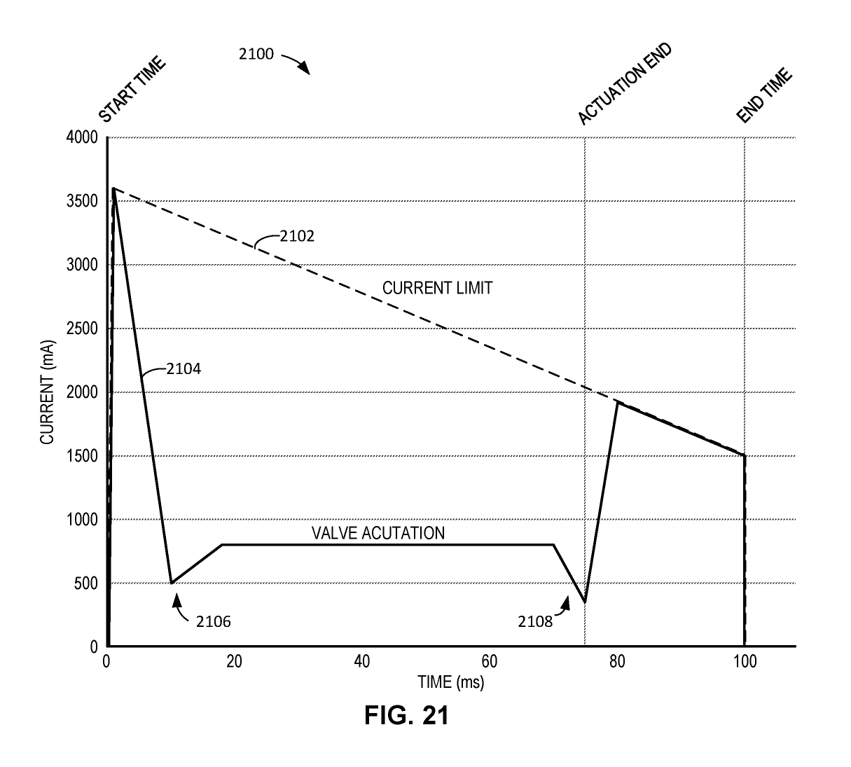

FIGS. 21-29 show graphs of example current limit profiles that can be implemented by the controller 408 during operation (e.g., opening or closing) the valve. In each of the example current limit profiles, the current limit is set to a first current limit at the start time, and then the current limit is changed or varied from the first current limit to a second current limit at or before the end time. In some examples, the second current limit is less than the first current limit, while in other examples the second current limit is greater than the first current limit. The example current limit profiles result in less total energy usage than traditional fixed current limit profiles. Further, the example current limit profiles reduce the forces or loads on the valve when starting the opening/closing operation and/or reaching the end stops at the open/closed position. This helps to reduce wear and tear on the actuator and valve components. This reduce wear enables the use of lighter, less expensive materials such as plastic. In each of the graphs in FIGS. 21-29, the X-axis is time in milliseconds (ms), and the Y-axis is current in milliamps (mA), the dashed lines represent the maximum current made available (i.e., the current limit) by the controller 408 during the time period, and the solid lines represent the measured current (i.e., current draw) that the actuator 522 actually draws from the power source during activation.

FIG. 21 shows an example graph 2100 with a current limit 2102 and a current draw 2104. In this example, the current limit 2102 is sloped downward. In particular, the current limit 2102 decreases at a linear rate between the start time and the end time. This may represent a valve opening actuation. At the start time, the current limit is set to a first current limit (e.g., 3600 mA) that is relatively high, and the controller 408 decreases the current limit 2102 at a linear rate from the first current limit to a second current limit (e.g., 1500 mA) at or before the end time. In this example, the second current limit is less than the first current limit. The first current limit at the start time is relatively high, which allows for a maximum start up current to get the valve moving quickly. During the valve actuation period, the draw current 2104 drops below the current limit 2102. Before the end time, when the valve reaches its end position (e.g., about 70 ms), the draw current 2104 again rises back to the current limit 2102. However, in this example, the current limit 2102 is much lower than the initial current limit. This reduced ending current results in a smaller area under the current draw 2104 compared to the graph in FIG. 20. As such, the actuator 522 consumes less energy during the activation time period. This reduced current limit also reduces the power output of the actuator 522 so as not to overload the components against the valve stop. As such, this reduces wear and tear on the components.

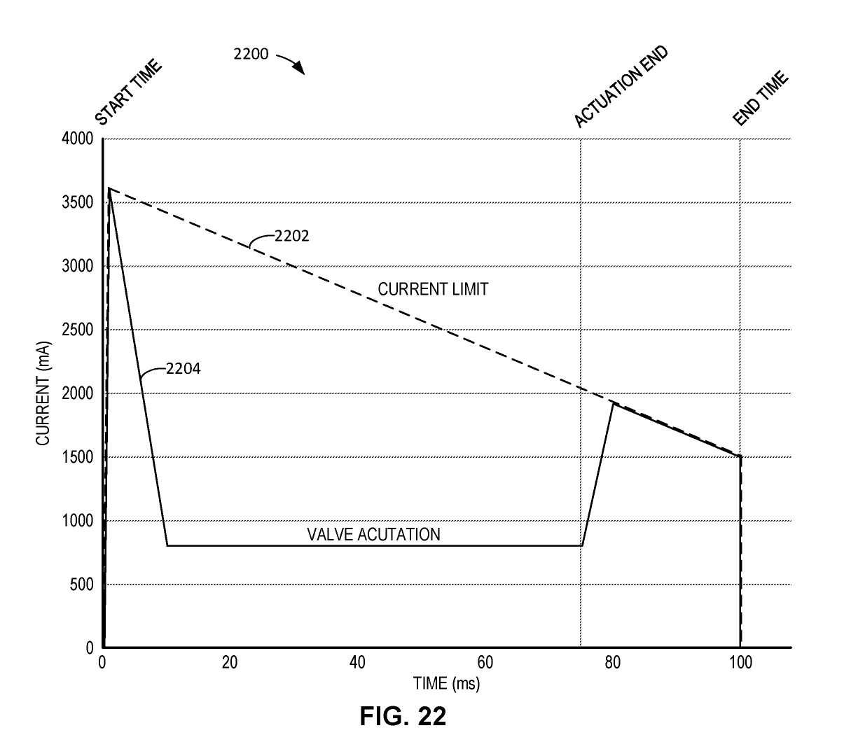

As shown in FIG. 21, the current draw 2104 has a slight dip 2106 after the initial start, and another dip 2108 at the end of the valve actuation. These dips 2106, 2108 can occur in linear style valves that may have pressure and latching bias. For example, these dips 2106 may occur when used with the valve 520 or the valve 1712. After the initial movement of the flow control member, a pressure or latching bias provides additional force in the direction of travel, which similarly occurs near the end of the actuation stroke. However, in other examples, the current draw may not include such dips in the current draw 2104. For example, FIG. 22 shows an example graph 2200 with an example current limit 2202 that is the same as in FIG. 21. In FIG. 22, the current draw 2204 is flat during the actuation portion. This profile can occur with rotary style valves, such as the valve 912 of FIGS. 9-16. Rotary valves and other non-volume displacing valves tend not to have the same pressure or latching bias seen on some linear style valves.

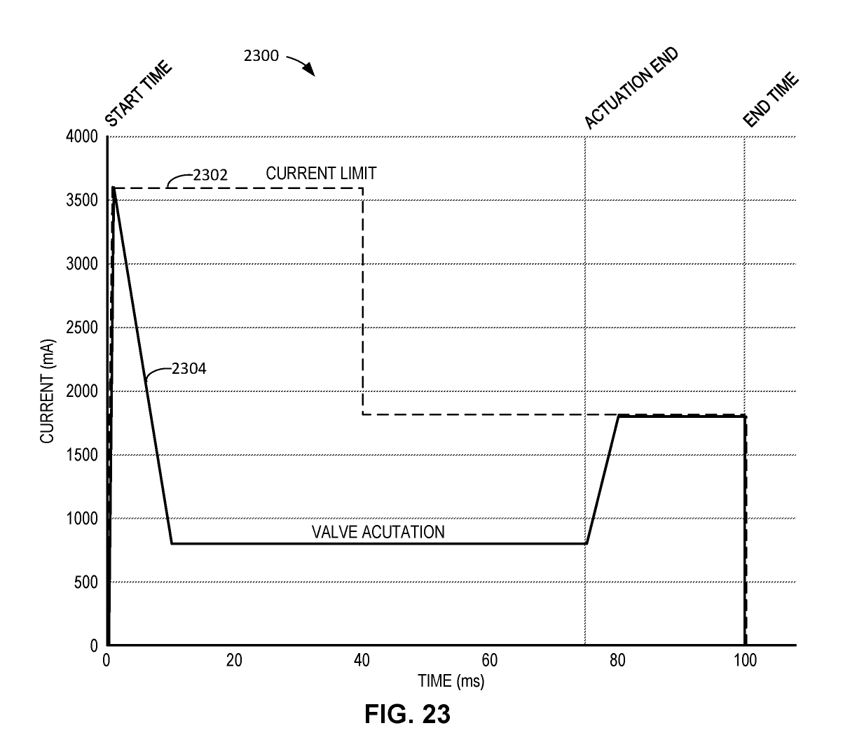

In some examples, the current limit can be stepped up or down. For example, FIG. 23 shows an example graph 2300 with an example current limit 2302 and a current draw 2304. In this example, the controller 408 holds the current limit 2302 at a first current limit (e.g., 3600 mA) for a first amount of time between the start time and an intermediate time (e.g., 40 ms). Then, the controller 408 reduces or steps down the current limit 2302 to a second current limit (e.g., 1700 mA) and holds the second current limit for a second amount of time between the intermediate time and the end time. In this example, the second current limit is less than the first current limit. As such, the area under the current draw 2304 at the end portion is less than in FIG. 20. This reduces energy consumption as well as reduces overloading of the valve components at the end stop.

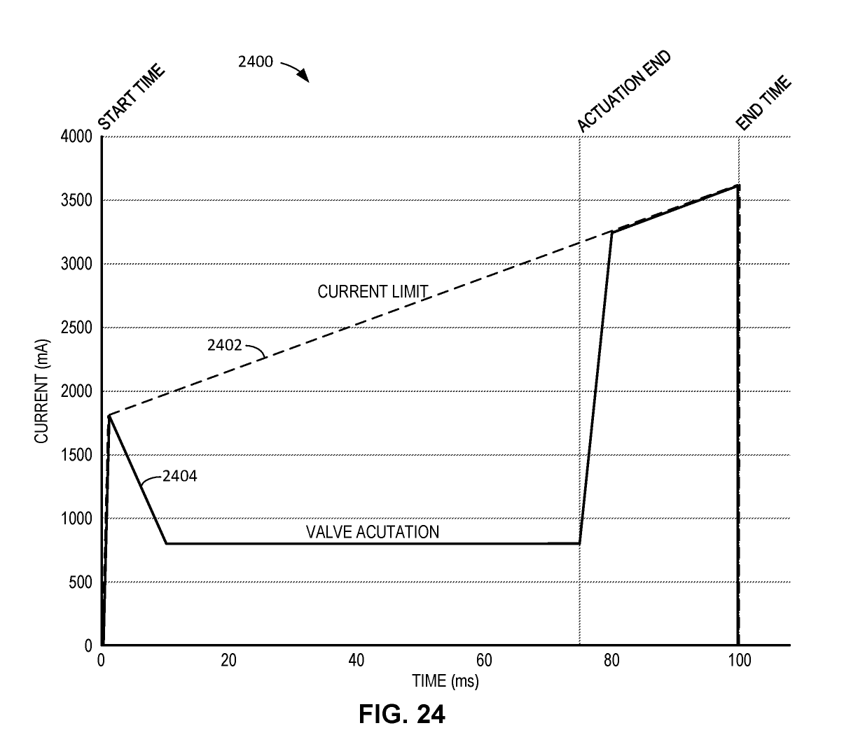

FIG. 24 shows an example graph 2400 with an example current limit 2402 and a current draw 2404. In this example, the current limit 2402 is sloped upward. In particular, the current limit 2402 increases at a linear rate from a first current limit (e.g., 1750 mA) at the start time to a second current limit (e.g., 3600 mA) at or before the end time. Therefore, in this example, the second current limit is greater than the first current limit. This current limit profile may be advantageous for valve designs in which it is desired to have a softer starting force but a harder closing force. The softer start results in lower energy consumption and less loading on the valve parts.

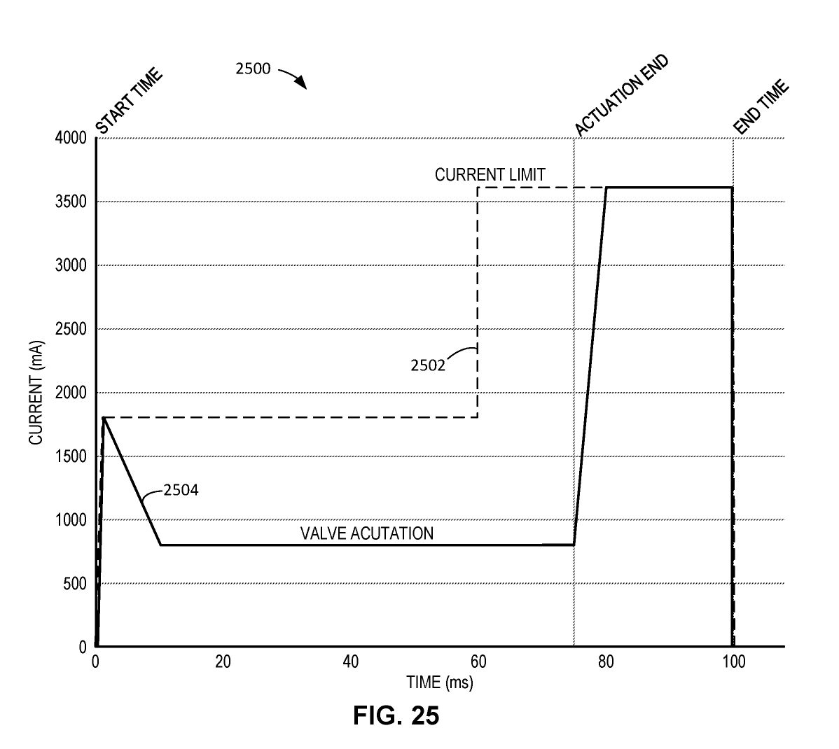

FIG. 25 shows an example graph 2500 with an example current limit 2502 and a current draw 2504. In this example, the current limit 2502 is stepped up. In particular, the current limit 2502 is held at a first current limit (e.g., 1750 mA) for a first amount of time between the start time and an intermediate time (40 ms), and then increased or stepped up to a second current limit (e.g., 3600 mA) and held at the second current limit for a second amount of time between the intermediate time and the end time. In this example, the second current limit is greater than the first current limit. This current limit profile may also be advantageous for a softer start force and a harder closing force. The softer start results in lower energy consumption and less loading on the valve parts.

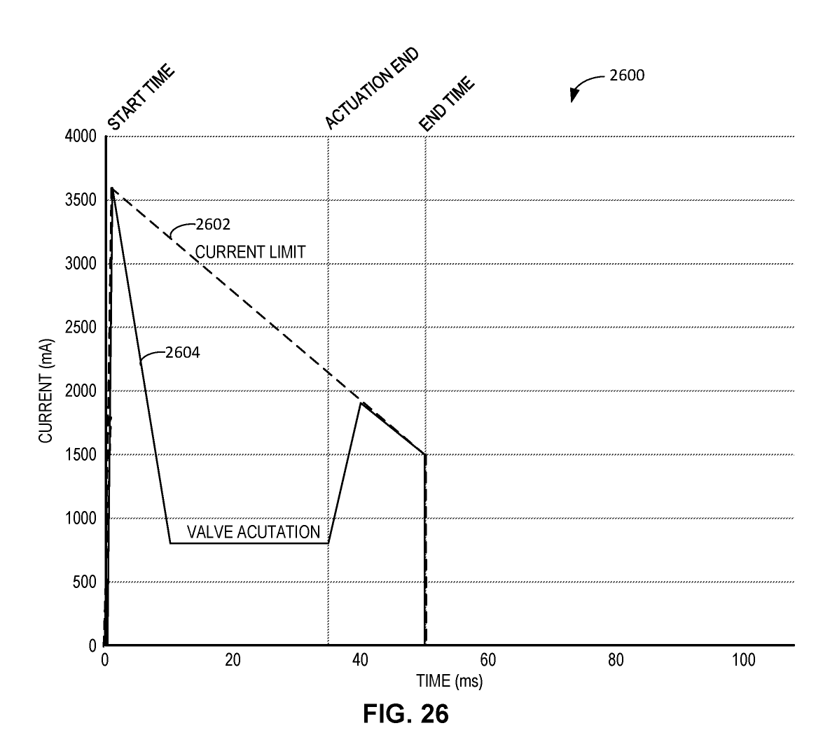

The predetermined time period during which the actuator 422 is activated can be increased or decreased depending on the valve design. For example, FIG. 26 shows an example graph 2600 with an example current limit 2602 and a current draw 2604. The valve actuation period is relatively short. As such, the time period can be shortened. For example, in FIG. 26, the activation time period is about 50 ms. This may occur during a valve closing operation in which the valve is a linear style valve. In some examples, the actuation time to close the valve 520 may be less than the actuation time to open the valve 520. In some examples, the controller 408 can implement a first time period (e.g., the time period of FIG. 21) when opening the valve 520, and implement a second time period (e.g., the time period FIG. 26) when closing the valve 520. The controller 408 can implement different current profiles when opening the valve 520 and closing the valve 520.

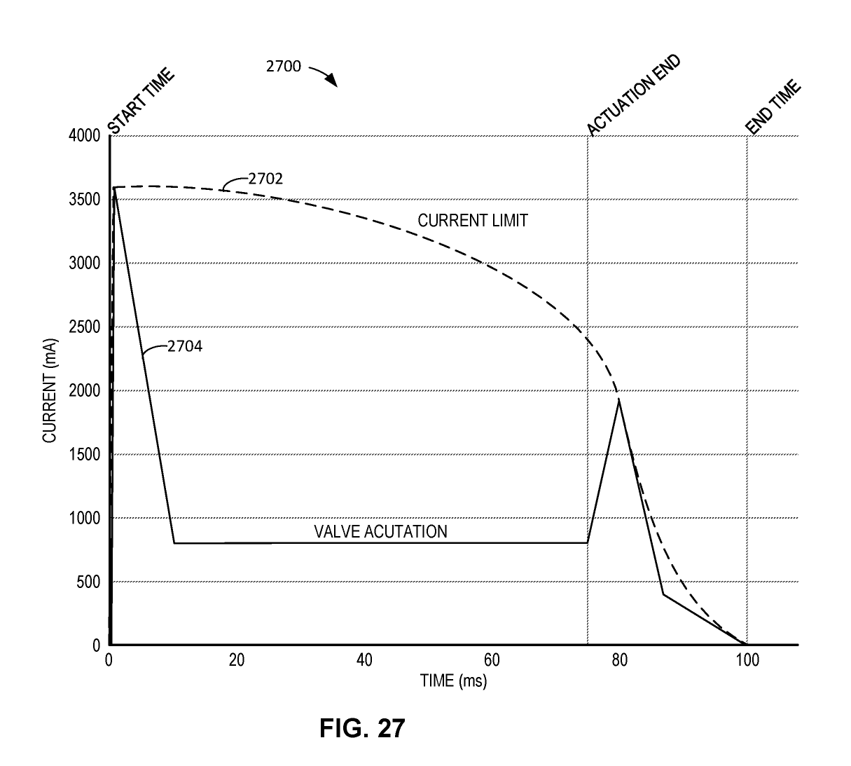

In some examples the current limit can change at a curvilinear (e.g., a predominantly non-linear or entirely non-linear) rate. For example, FIG. 27 shows an example graph 2700 with an example current limit 2702 and a current draw 2704. In this example, the current limit 2702 decreases at a curvilinear rate. At the start time the current limit 2702 is set to a first current limit (e.g., 3600 mA), and is then reduced at a curvilinear rate down to a second current limit (e.g., 0 mA) at the end time. Therefore, the controller 408 can change the first current limit to the second current limit at a curvilinear rate.

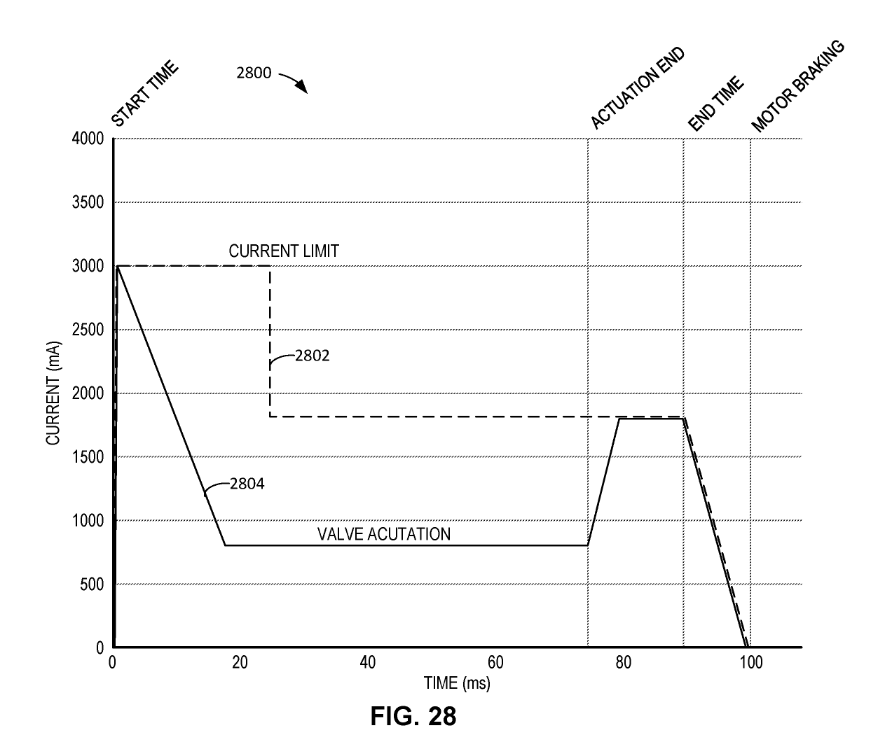

FIG. 28 shows an example graph 2800 with an example current limit 2802 and a current draw 2804. The example current limit 2802 has a stepped-down profile similar to FIG. 23. In the example of FIG. 28, after the time period is reached (e.g., at 100 ms), actuator braking (e.g., motor braking) is applied. In particular, the actuator braking circuitry 1906 shorts the positive and negative electrical terminals or wires of the actuator 522. For example, the actuator braking circuitry 1906 can electrically couple the first and second wires 532, 534 (FIG. 5). This results in a downward sloping of the current limit 2802 that slopes down to zero. The downward sloping of the current limit ensures a smooth slow-down so that the valve 520 does not recoil out of the valve end position (e.g., the open position or the closed position). In this example, the actuator braking occurs over a time period of about 20 ms, but in other examples can be longer or shorter.

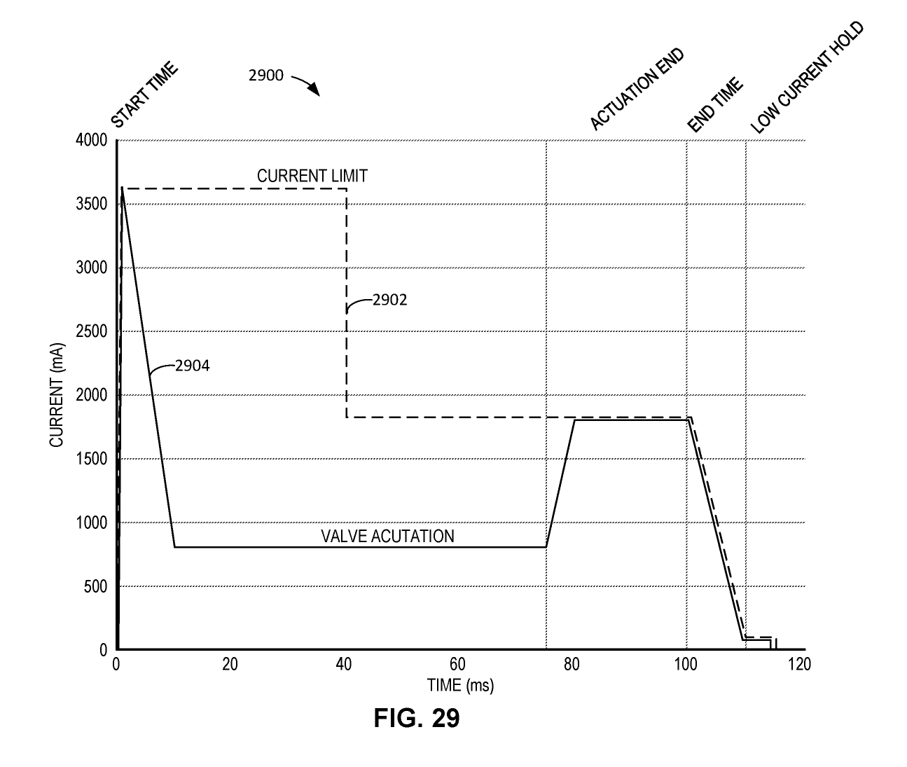

FIG. 29 shows an example graph 2900 with an example current limit 2902 and a current draw 2904. The current limit 2902 a stepped-down profile similar to FIG. 23. After the time period is reached (e.g., at 100 ms), the current limit 2902 is downward sloping to a third current limit (e.g., 100 mA) and is held at the third current limit for a second time period. In other words, at the end time, the power controller circuitry 1900 decreases the current limit at a linear rate down to a third current limit (e.g. 100 mA). In some examples, the third current limit is 1-20% of the maximum current limit. The third current limit is held for a short period of time, such as about 20 ms, or may be as long as the rider continues to activate the valve open control. The low current hold ensures the valve 520 does not recoil out of the actuation end position.

In each of example profiles of FIGS. 21-29, the current limit is changed from a first current limit at the start time of the time period to a second current limit at or before the end time of the time period. Further, in each of the example profiles of FIGS. 21-29, the current limit at the end time is different than the current limit at the start time, though this need not be the case. For example, the current limit can start at a first current limit, decrease to a second current limit, and then increase back to the first current limit at the end time. Such a profile may still result in less area under the current draw curve and, thus, result in less energy consumption.

The example controller 408 can be configured to implement any of the example current limit profiles of FIGS. 21-29. In some examples, one of the current limit profiles is pre-installed in the controller 408 (e.g., stored in a memory of the controller 408) by the manufacturer. Each time the valve is opened or closed, the controller 408 activates the actuator 522 according to the selected current limit profile. In other examples, the current limit profile can be set by the end user. In some examples, the controller 408 can select between two or more of the current limit profiles. For example, during a first valve actuation event, the controller 408 can implement a first one of the current limit profiles, and during a second valve actuation event, the controller can implement a second one of the current limit profiles. In some examples, multiple ones of the current limit profiles are stored in a memory of the controller 408. In some examples, the predetermined time period over which the actuator 522 is activated can be variable. For example, during a first valve actuation event like a valve open event, the predetermined time period may be a first length of time (e.g., 100 ms), and during a second valve actuation event like a valve close event, the predetermined time period may be a second length of time (e.g., 90 ms). In some examples, the controller 408 can adjust the predetermined time period and/or select the current limit profile based on a prior valve actuation event. In some examples, the controller 408 can adjust the predetermined time period and/or select the current limit profile based on a temperature (because temperature affects the rate at the valve opens/closes), and/or by an actual current draw from the actuator 522, at a time prior to the start of the actuation event. In some examples, the seat post 200 includes a temperature sensor to detect and/or otherwise measure temperature (e.g., temperature of the internal fluid and/or ambient temperature). The controller 408 may also adjust the predetermined time period and/or select the current limit profile based on a count value of previous actuation events, for example to account for operation cycles and potential fouling. For example, the controller 408 may track and store the count value in a memory, and may adjust the predetermined time period and/or select the current limit profile when the count value reaches certain thresholds.

In some examples, the seat post 200 does not include a positional encoder to determine the state or position of the valve 520. Instead, the controller 408 activates the actuator 522 for a fix or predetermined period of time that is sufficient for the valve 520 to fully open or fully close. Eliminating the need for a positional encoder reduces weight and costs.

While an example manner of implementing the controller 408 of FIG. 4 is illustrated in FIG. 19, one or more of the elements, processes, and/or devices illustrated in FIG. 19 may be combined, divided, re-arranged, omitted, eliminated, and/or implemented in any other way. Further, the example power control circuitry 1900, the example current limit determination circuitry 1902, the example duty cycle circuitry 1904, the example actuator braking circuitry 1906, and/or, more generally, the example controller 408 of FIG. 19, may be implemented by hardware alone or by hardware in combination with software and/or firmware. Thus, for example, any of the example power control circuitry 1900, the example current limit determination circuitry 1902, the example duty cycle circuitry 1904, the example actuator braking circuitry 1906, and/or, more generally, the example controller 408, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example controller 408 of FIG. 19 may include one or more elements, processes, and/or devices in addition to, or instead of, those illustrated in FIG. 19, and/or may include more than one of any or all of the illustrated elements, processes and devices.

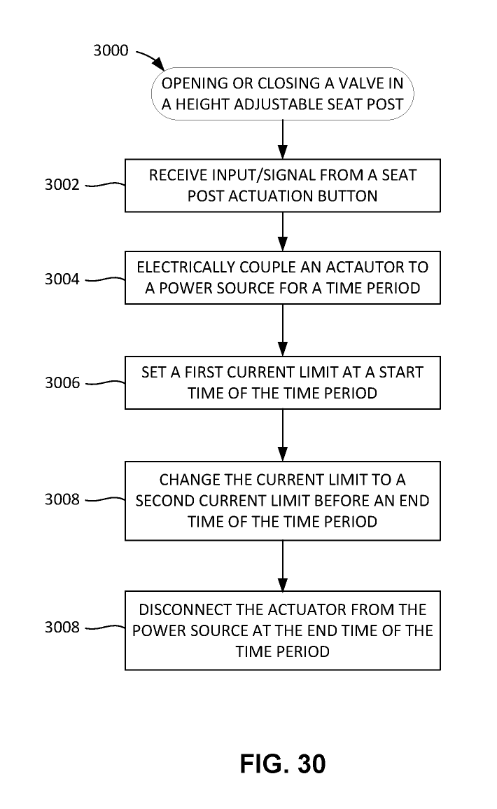

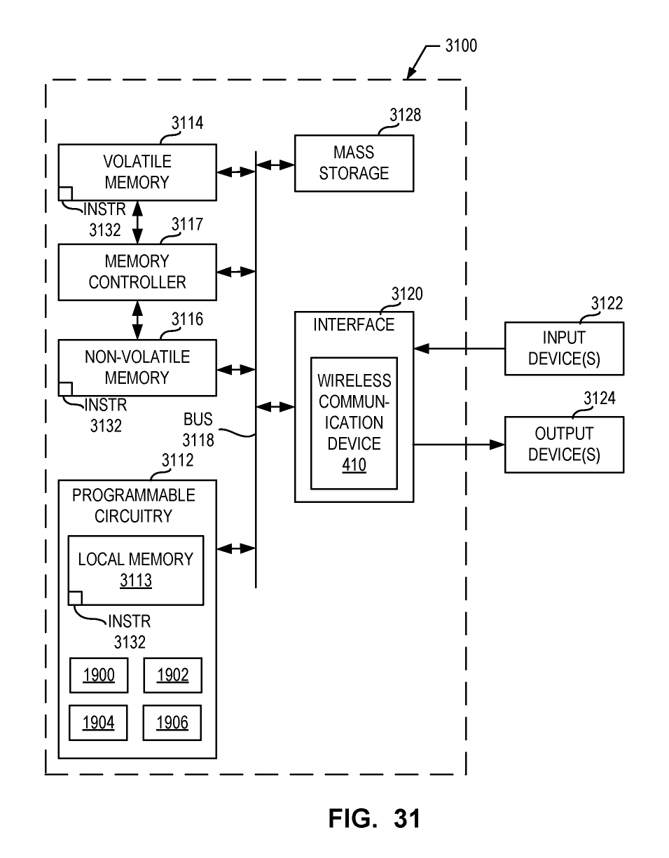

Flowchart(s) representative of example machine readable instructions, which may be executed by programmable circuitry to implement and/or instantiate the controller 408 of FIG. 19 and/or representative of example operations which may be performed by programmable circuitry to implement and/or instantiate the controller 408 of FIG. 19, are shown in FIG. 30. The machine readable instructions may be one or more executable programs or portion(s) of one or more executable programs for execution by programmable circuitry such as the programmable circuitry 3112 shown in the example processor platform 3100 discussed below in connection with FIG. 31. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). Further, although the example program is described with reference to the flowchart(s) illustrated in FIG. 30, many other methods of implementing the example controller 408 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above

As mentioned above, the example operations of FIG. 30 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 30 is a flowchart representative of example machine readable instructions and/or example operations 3000 that may be executed, instantiated, and/or performed by programmable circuitry to open or close valve in a height adjustable seat post. The example operations 3000 are described in connection with the height adjustable seat post 200 with the linear valve 520 and the actuator 522 (i.e., an electric motor) shown in FIGS. 5-7. However, the example operations 3000 can be similarly performed in connection with the other examples valves and actuators disclosed herein. Further, for sake of example, the operations 3000 of FIG. 30 are described in connection with a valve opening operation. Therefore, it is assumed the valve 520 is in the closed position. However, the example operations 3000 can be similarly implemented for performing a valve closing operation.

At block 3002, the controller 408 waits for a signal or input from the seat post actuation button 113. When a rider desires to adjust the height of the seat 110, the rider presses the seat post actuation button 113. The seat post actuation button 113 may communicate wirelessly or via a wired connection with the controller 408. The controller 408 receives a signal or input indicating the seat post actuation button 113 has been pressed.

In response to receipt of the signal indicating the seat post actuation button 113 has been pressed, the controller 408, at block 3004, electrically couples the actuator 522 to the power source for a time period. For example, the power controller circuitry 1900 may include one or more switches (e.g., transiters) that create a closed circuit to electrically couple the actuator 522 to the battery 404, thereby suppling electrical power to the actuator 522. The flow of electrical power activates the actuator 522 to move the valve 520 from the closed position to the open position (or from the open position to the closed position). The time period is a fixed or predetermined time period, such as 100 ms. The time period has a start time and an end time.

At block 3006, the controller 408 sets a first current limit at the start time of the time period. For example, in each of FIGS. 21-29, a first current limit is set at the start time. The controller 408 may implement any one of the current profiles shown in FIGS. 21-28. The first current limit may be determined by the current limit determination circuitry 1902 according to the current limit profile. In some examples, the power control circuitry 1900 can change and/or otherwise control the current limit using a pulse width modulation of the voltage. For example, the power control circuitry 1900 can cycle on and off the electrical connection (e.g., by opening and closing a switch) at a specific frequency and duty cycle. This voltage cycling effectively controls the current limit available to the actuator 522.

At block 3008, during the time period, the controller 408 changes the current limit to a second current limit before the end time of the time period. As shown in connection with FIGS. 21-29, the controller 408 may increase or decrease the current limit during the time period. In some examples, the current limit is increased or decreased at a linear rate, a stepped rate, or at a curvilinear rate.

At block 3010, the controller 408 disconnects the actuator 522 from the power source at the end time of the time period. For example, the power control circuitry 1900 electrically decouples or disconnects the battery 404 and the actuator 522, which deactivates the actuator 522. In some examples, at the end time, the controller 408 is configured to short the actuator 522, such as shown in the example profile of FIG. 28. For example, the actuator braking circuitry 1906 can electrically couple the positive and negative terminals of the actuator 522 to short the positive and negative terminals and thereby apply actuator braking (e.g., motor braking). In some examples, the time period is a first time period, and the controller 408 is configured to, at the end time, decrease the current limit at a linear rate to a third current limit and hold the third current limit for a second time period, such as shown in the example current limit profile of FIG. 29. After block 3010, the example valve opening operation ends.

When the rider releases the seat post actuation button 113, the controller 408 performs the same operations 3000 to activate the actuator to move the valve from the open position to the closed position. The controller 408 may sense the seat post actuation button 113 has been released by detecting a lack of signal from the seat post actuation button 113, or may receive a separate signal from the seat post actuation button 113. In other examples, the rider may release the seat post actuation button 113 and then press the seat post actuation button 113 a second time to cause the valve 520 to move to the closed position. After the valve 420 is closed, the controller 408 waits for the rider to press the seat post actuation button 113 again and the entire operation is repeated.

FIG. 31 is a block diagram of an example programmable circuitry platform 3100 that can be implemented by the controller 408 and structured to execute and/or instantiate the example machine-readable instructions and/or the example operations of FIG. 30.

The programmable circuitry platform 3100 of the illustrated example includes programmable circuitry 3112. The programmable circuitry 3112 of the illustrated example is hardware. For example, the programmable circuitry 3012 can be implemented by one or more integrated circuits, logic circuits, FPGAs, microprocessors, CPUs, GPUs, VPUs, DSPs, and/or microcontrollers from any desired family or manufacturer. The programmable circuitry 3112 may be implemented by one or more semiconductor based (e.g., silicon based) devices. In this example, the programmable circuitry 3112 implements the example power control circuitry 1900, the example current limit determination circuitry 1902, the example duty cycle circuitry 1904, and the example motor braking circuitry 1906.

The programmable circuitry 3112 of the illustrated example includes a local memory 3113 (e.g., a cache, registers, etc.). Additionally or alternatively, the programmable circuitry platform 3100 can include main memory 3114, 3116, which includes a volatile memory 3114 and a non-volatile memory 3116. The programmable circuitry 3112 of the illustrated example is in communication with main memory 3114, 3116 by a bus 3118. The volatile memory 3114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3116 may be implemented by flash memory and/or any other desired type of memory device. Access to the main memory 3114, 3116 of the illustrated example is controlled by a memory controller 3117. In some examples, the memory controller 3117 may be implemented by one or more integrated circuits, logic circuits, microcontrollers from any desired family or manufacturer, or any other type of circuitry to manage the flow of data going to and from the main memory 3114, 3116.

The programmable circuitry platform 3100 of the illustrated example also includes interface circuitry 3120. The interface circuitry 3120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 3122 are connected to the interface circuitry 3120. The input device(s) 3122 permit(s) a user (e.g., a human user, a machine user, etc.) to enter data and/or commands into the programmable circuitry 3112. The input device(s) 3122 can be implemented by, for example, the seat post actuation button 113. Another example input device 3122 includes a temperature sensor. Additionally or alternatively, the input device(s) 3122 can include an audio sensor, a microphone, a camera (still or video), a keyboard, a button, a mouse, a touchscreen, a trackpad, a trackball, an isopoint device, and/or a voice recognition system.

One or more output devices 3124 are also connected to the interface circuitry 3120 of the illustrated example. The output device(s) 3124 can be implemented, for example, the actuator 522. Additionally or alternatively, the output device(s) 3124 can include a light, a speaker, a or display device (e.g., a light emitting diode (LED), an organic light emitting diode (OLED), a liquid crystal display (LCD), a cathode ray tube (CRT) display, an in-place switching (IPS) display, a touchscreen, etc.).

The interface circuitry 3120 of the illustrated example can also include a communication device, such as the wireless communication device 410. In some examples, the wireless communication device 410 is used to communicate with the input device(s) 3122 and/or output device(s) 3124. In other examples, the input device(s) 3122 and/or output device(s) 3124 can be connected to the interface circuitry 3120 via a physical wired connection.

The programmable circuitry platform 3100 of the illustrated example can also include one or more mass storage discs or devices 3128 to store firmware, software, and/or data. Examples of such mass storage discs or devices 3128 include magnetic storage devices (e.g., drives, HDDs, etc.), and/or solid-state storage discs or devices such as flash memory devices and/or SSDs.

The machine readable instructions 3132, which may be implemented by the machine readable instructions of FIG. 30, may be stored in the mass storage device 3128, in the volatile memory 3114, in the non-volatile memory 3116, and/or on at least one non-transitory computer readable storage medium that may be removable.

While the example piston assemblies, valves, actuators, and controllers disclosed herein are described in connection with seat posts having a pneumatic platform, the examples disclosed herein can also be used in connection with hydraulic platforms. For example, instead of having pneumatic chambers filled with pressurized gas, the chambers 516, 518 can be filled with a hydraulic fluid, such as oil. Therefore, the examples disclosed herein can be used in connection with valves for compressible or incompressible fluids. Also, while the examples disclosed herein utilize a battery in the control module as the power supply to activate the actuator, in other examples, the actuator can be activated from another power supply, such as an electric bicycle battery or from another battery attached to the bicycle.

The example piston assemblies, valves, actuators, and controllers can also be used in other types of bicycle components. For example, any of the example piston assemblies, valves, actuators, and controllers can be used in suspension components (e.g., a shock absorber, a front fork). A suspension component often includes first and second tubes arranged in a telescopic arrangement. The example piston assemblies, valves, and actuators disclosed herein can be used as a damper or a spring component to control the flow of fluid between two chambers in the tube(s). The example controllers and current limit techniques disclosed herein can be used to reduce energy consumption and reduce hard starting/stopping forces in such a component.

Example systems, apparatus, and articles of manufacture for bicycles (and/or other vehicles) are disclosed herein. Examples and combinations of examples disclosed herein include the following clauses:

A height adjustable seat post for a bicycle, the height adjustable seat post comprising: a first tube and a second tube configured in a telescopic arrangement, one of the first tube or the second tube to be coupled to a frame of the bicycle, the other of the first tube or the second tube to be coupled to a seat; a first chamber; a second chamber; a valve disposed between the first chamber and the second chamber, the valve to control a fluid flow between the first and second chambers, the valve operable between a closed state in which the fluid flow is blocked and an open state in which the fluid flow is enabled; an actuator to operate the valve between the closed state and the open state; and a controller to operate the actuator with a power source to move the valve between the closed state and the open state, the controller to control a current limit of effective current available to the actuator during operation of the valve, the controller to set a first current limit and to change the current limit to a second current limit during operation of the valve.

The height adjustable seat post of any preceding clause, wherein the controller is to operate the actuator to move the valve between the closed state and the open state by electrically coupling the actuator to the power source for a predetermined period of time, the predetermined time period having a start time and an end time, and wherein the controller is to set the first current limit at the start time and change the current limit to the second current limit before the end time.

The height adjustable seat post of any preceding clause, wherein the controller is to adjust the predetermined time period based on a count value of previous actuation events.

The height adjustable seat post of any preceding clause, wherein the controller is to adjust the predetermined time period based on a temperature.

The height adjustable seat post of any preceding clause, wherein the controller is to control the current limit of effective current available using pulse width modulation.

The height adjustable seat post of any preceding clause, wherein the second current limit is less than the first current limit, and wherein the controller is to decrease the current limit at a linear rate from the first current limit to the second current limit.

The height adjustable seat post of any preceding clause, wherein the second current limit is greater than the first current limit, and wherein the controller is to increase the current limit at a linear rate from the first current limit to the second current limit.

The height adjustable seat post of any preceding clause, wherein the controller is to activate the actuator for a predetermined time period having a start time and an end time, wherein the controller is to hold the first current limit for a first amount of time between the start time and an intermediate time, and wherein the controller is to hold the second current limit for a second amount of time between the intermediate time and the end time.

The height adjustable seat post of any preceding clause, wherein the second current limit is less than the first current limit.

The height adjustable seat post of any preceding clause, wherein the second current limit is greater than the first current limit.

The height adjustable seat post of any preceding clause, wherein the controller is to change the first current limit to the second current limit at a curvilinear rate.

The height adjustable seat post of any preceding clause, further including a switch, wherein the controller is to activate the actuator for a predetermined time period having a start time and an end time, and wherein the controller is to, at the end time, control the switch to electrically couple positive and negative terminals of the actuator to short the positive and negative terminals and apply actuator braking.

The height adjustable seat post of any preceding clause, wherein the controller is to activate the actuator for a first time period having a start time and an end time, and wherein the controller is to, at the end time, decrease the current limit at a linear rate to a third current limit and hold the third current limit for a second time period.

The height adjustable seat post of any preceding clause, wherein the actuator is an electric motor.

The height adjustable seat post of any preceding clause, wherein the actuator is a solenoid.

The height adjustable seat post of any preceding clause, wherein the valve is a linear valve having a flow control member that is moveable in a linear direction between a closed position and an open position.

The height adjustable seat post of any preceding clause, wherein the actuator is an electric motor, the height adjustable seat post further including a cam assembly to convert rotational motion of the electric motor to linear movement of the plug, the cam assembly including a first cam, a second cam, and a plurality of balls between the first cam and the second cam, wherein rotation of the second cam in a first direction causes the first cam to move toward the plug to move the plug to the open position, and wherein rotation of the second cam in a second direction enables the first cam to move away from the plug to enable the plug to move to the closed position.

The height adjustable seat post of any preceding clause, wherein the valve is a rotary valve.

The height adjustable seat post of any preceding clause, wherein the rotary valve includes a fixed disc and a rotary disc that is rotatable relative to the fixed disc between a closed position and an open.

The height adjustable seat post of any preceding clause, wherein the actuator is an electric motor, the height adjustable seat post further including a gear system to reduce a valve speed relative to a motor speed, the gear system including one or more gears constructed of plastic.

The height adjustable seat post of any preceding clause, wherein the actuator is disposed in the first tube.

The height adjustable seat post of any preceding clause, wherein the actuator is disposed at a lower end of the second tube.

A bicycle component comprising: a first tube and a second tube configured in a telescopic arrangement; a piston assembly in the first tube, the piston assembly dividing the first tube into a first chamber and a second chamber, the first and second chambers filled with a fluid, the piston assembly including a valve to control flow of the fluid between the first and second chambers, the valve operable between a closed state in which the fluid is blocked from flowing across the valve between the first and second chambers and an open state to enable the fluid to flow across the valve between the first and second chambers; an actuator to operate the valve between the closed state and the open state; and circuitry to control a supply of electrical power to the actuator for a predetermined time period to enable the valve to change from the closed state to the open state or from the open state to the closed state, the circuitry to vary a current limit of available current to the actuator during the time period.

The bicycle component of any preceding clause, wherein the circuitry is to change the current limit by changing a duty cycle of the supply of electrical power to the actuator.

The bicycle component of any preceding clause, wherein the predetermined time period has a start time and an end time, and wherein the circuitry is to decrease the current limit from a first current limit at the start time to a second current limit before or at the end time, the second current limit lower than the first current limit.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Descriptors "first," "second," "third," etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor "first" may be used to refer to an element in the detailed description, while the same element may be referred to in a claim with a different descriptor such as "second" or "third." In such instances, it should be understood that such descriptors are used merely for ease of referencing multiple elements or components.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A height adjustable seat post for a bicycle, the height adjustable seat post comprising:
a first tube and a second tube configured in a telescopic arrangement, one of the first tube or the second tube to be coupled to a frame of the bicycle, the other of the first tube or the second tube to be coupled to a seat;
a first chamber;
a second chamber;
a valve disposed between the first chamber and the second chamber, the valve to control a fluid flow between the first and second chambers, the valve operable between a closed state in which the fluid flow is blocked and an open state in which the fluid flow is enabled;
an actuator to operate the valve between the closed state and the open state; and
a controller to operate the actuator with a power source to move the valve between the closed state and the open state, the controller to control a current limit of effective current available to the actuator during operation of the valve, the controller to set a first current limit and to change the current limit to a second current limit during operation of the valve.

2. The height adjustable seat post of claim 1, wherein the controller is to operate the actuator to move the valve between the closed state and the open state by electrically coupling the actuator to the power source for a predetermined period of time, the predetermined time period having a start time and an end time, and wherein the controller is to set the first current limit at the start time and change the current limit to the second current limit before the end time.

3. The height adjustable seat post of claim 2, wherein the controller is to adjust the predetermined time period based on a count value of previous actuation events.

4. The height adjustable seat post of claim 2, wherein the controller is to adjust the predetermined time period based on a temperature.

5. The height adjustable seat post of claim 1, wherein the controller is to control the current limit of effective current available using pulse width modulation.

6. The height adjustable seat post of claim 1, wherein the second current limit is less than the first current limit, and wherein the controller is to decrease the current limit at a linear rate from the first current limit to the second current limit.

7. The height adjustable seat post of claim 1, wherein the controller is to activate the actuator for a predetermined time period having a start time and an end time, wherein the controller is to hold the first current limit for a first amount of time between the start time and an intermediate time, and wherein the controller is to hold the second current limit for a second amount of time between the intermediate time and the end time.

8. The height adjustable seat post of claim 7, wherein the second current limit is less than the first current limit.

9. The height adjustable seat post of claim 7, wherein the second current limit is greater than the first current limit.

10. The height adjustable seat post of claim 1, further including a switch, wherein the controller is to activate the actuator for a predetermined time period having a start time and an end time, and wherein the controller is to, at the end time, control the switch to electrically couple positive and negative terminals of the actuator to short the positive and negative terminals and apply actuator braking.

11. The height adjustable seat post of claim 1, wherein the controller is to activate the actuator for a first time period having a start time and an end time, and wherein the controller is to, at the end time, decrease the current limit at a linear rate to a third current limit and hold the third current limit for a second time period.

12. The height adjustable seat post of claim 1, wherein the actuator is an electric motor.

13. The height adjustable seat post of claim 1, wherein the actuator is a solenoid.

14. The height adjustable seat post of claim 1, wherein the valve is a linear valve having a plug that is moveable linearly between an open position and a closed position and wherein the actuator is an electric motor, the height adjustable seat post further including a cam assembly to convert rotational motion of the electric motor to linear movement of the plug, the cam assembly including a first cam, a second cam, and a plurality of balls between the first cam and the second cam, wherein rotation of the second cam in a first direction causes the first cam to move toward the plug to move the plug to the open position, and wherein rotation of the second cam in a second direction enables the first cam to move away from the plug to enable the plug to move to the closed position.

15. The height adjustable seat post of claim 1, wherein the valve is a rotary valve.

16. The height adjustable seat post of claim 1, wherein the actuator is an electric motor, the height adjustable seat post further including a gear system to reduce a valve speed relative to a motor speed, the gear system including one or more gears constructed of plastic.

17. The height adjustable seat post of claim 1, wherein the actuator is disposed at a lower end of the second tube.

18. A bicycle component comprising:
a first tube and a second tube configured in a telescopic arrangement;
a piston assembly in the first tube, the piston assembly dividing the first tube into a first chamber and a second chamber, the first and second chambers filled with a fluid, the piston assembly including a valve to control flow of the fluid between the first and second chambers, the valve operable between a closed state in which the fluid is blocked from flowing across the valve between the first and second chambers and an open state to enable the fluid to flow across the valve between the first and second chambers;
an actuator to operate the valve between the closed state and the open state; and
circuitry to control a supply of electrical power to the actuator for a predetermined time period to enable the valve to change from the closed state to the open state or from the open state to the closed state, the circuitry to vary a current limit available to the actuator during the time period.

19. The bicycle component of claim 18, wherein the circuitry is to control the current limit by changing a duty cycle of the supply of electrical power to the actuator.

20. The bicycle component of claim 18, wherein the predetermined time period has a start time and an end time, and wherein the circuitry is to decrease the current limit from a first current limit at the start time to a second current limit before or at the end time, the second current limit lower than the first current limit.
